(19) United States
(12) Patent Application Publication
(10) Pub. No.: US 2026/0322961 A1
(43) Pub. Date: Oct. 15, 2026

(54) VIDEO PROCESSING METHOD, PROGRAM, AND VIDEO PROCESSING SYSTEM

(71) Applicant: Panasonic Projector & Display Corporation, Osaka (JP)

(72) Inventor: Yoshinao SUGIURA, Osaka (JP)

(21) Appl. No.: 19/707,783

(22) Filed: Jun. 15, 2026

Related U.S. Application Data
(63) Continuation of application No. PCT/JP2024/044992, filed on Dec. 19, 2024.

(30) Foreign Application Priority Data
Dec. 28, 2023 (JP) 2023-222242

(51) Int. Cl. H04N 9/31; G06T 7/73

(52) U.S. Cl. CPC H04N 9/3194; G06T 7/74; H04N 9/3147; H04N 9/3185; G06T 2207/10016

(57) ABSTRACT

A video processing method enables a viewer to detect a pattern image to be superimposed on a video in order to correct a deviation in a display position of the video without being perceived. The video processing method acquires the pattern image from the one or more superimposed subframes acquired. The video processing method adjusts a degree of acquiring the pattern image from one or more superimposed subframes acquired by increasing or decreasing the degree according to a result of acquiring the pattern image.

### CROSS REFERENCE TO RELATED APPLICATION

This is a continuation application of International Application No. PCT/JP2024/044992, with an international filing date of Dec. 19, 2024, which claims priority of Japanese Patent Application No. 2023-222242 filed on Dec. 28, 2023, each of the content of which is incorporated herein by reference in its entirety.

### TECHNICAL FIELD

The present disclosure relates to a video processing method, a program, and a video processing system.

### BACKGROUND ART

WO 2018/225531 A discloses an image processing apparatus. In this image processing apparatus, homography transformation is applied to a pattern captured image obtained by imaging a predetermined structured light pattern projected by a projection unit by an imaging unit. Then, the image processing apparatus detects corresponding points between a projection image projected by the projection unit and a captured image captured by the imaging unit using the pattern captured image to which the homography transformation is applied.

### SUMMARY

The present disclosure provides a video processing method and the like in which a pattern image to be superimposed on a video in order to correct a deviation of a display position of the video is easily detected without being perceived by a viewer.

A video processing method according to one aspect of the present disclosure includes: acquiring a plurality of subframes obtained by temporally dividing a frame included in video data; outputting one or more superimposed subframes in which a pattern image is superimposed on one or more subframes based on the plurality of subframes so as to be displayed on a display surface; acquiring the one or more superimposed subframes displayed on the display surface by imaging; acquiring the pattern image from the one or more superimposed subframes acquired; detecting a deviation of a display position of a video projected on the display surface by comparing a feature point of the pattern image acquired with a reference feature point; and adjusting a degree of acquiring the pattern image from the one or more superimposed subframes acquired according to a result of acquiring the pattern image.

The present disclosure has an advantage that the pattern image to be superimposed on the video in order to correct the deviation of the display position of the video is easily detected without being perceived by the viewer.

### BRIEF DESCRIPTION OF THE DRAWINGS

FIG. 1 is a schematic diagram showing an overall configuration including a video processing system according to an embodiment.

FIG. 2 is a block diagram showing a configuration of a projection device according to the embodiment.

FIG. 3 is a flowchart showing an example of embedding determination.

FIG. 4 is a flowchart showing an example of generating a plurality of subframes.

FIG. 5 is a diagram showing an example of a pattern image.

FIG. 6 is an explanatory diagram of an operation example of a video selecting unit of the projection device according to the embodiment.

FIG. 7 is a schematic diagram of a video projecting unit of the projection device according to the embodiment.

FIG. 8 is a diagram showing a correlation between a control signal given to an optical path shift element and a video signal.

FIG. 9 is a block diagram showing a configuration of an imaging device according to the embodiment.

FIG. 10 is a flowchart showing an example of pattern image detection.

FIG. 11 is a block diagram showing a configuration of a control device according to the embodiment.

FIG. 12 is a flowchart showing an example of initialization of deviation correction.

FIG. 13 is a diagram showing an example of a feature point of a third pattern image.

FIG. 14 is a flowchart showing an example of the deviation correction.

FIG. 15 is a flowchart showing an operation example of deviation correction of the video processing system according to the embodiment.

FIG. 16 is an explanatory diagram of a first example of adjusting.

FIG. 17 is an explanatory diagram of a second example of the adjusting.

FIG. 18 is an explanatory diagram of a third example of the adjusting.

FIG. 19 is a diagram showing an example of a mask image used in the third example of the adjusting.

FIG. 20 is a sequence diagram showing an operation example of the video processing system according to the embodiment.

FIG. 21 is a schematic diagram showing an overall configuration including the video processing system according to a first modification of the embodiment.

FIG. 22 is a sequence diagram showing the operation example of the video processing system according to the first modification of the embodiment.

FIG. 23 is a sequence diagram showing the operation example of the video processing system according to a second modification of the embodiment.

### DETAILED DESCRIPTION

### 1. Knowledge Underlying the Present Disclosure

First, attention points of the inventor will be described below.

Conventionally, in order to correct distortion of a projection image projected on a display surface of a screen or the like by a projection device (projector), that is, a deviation of a display position of the projection image, a video processing method of capturing the projection image by an imaging device and performing geometric correction of the projection image using a captured image is known. The deviation of the display position of the projection image can be caused by disturbance such as displacement of the projection device due to vibration or the like. As such a video processing method, the inventor of the present application has studied a method of performing the geometric correction of the projection image without being perceived by a viewer while the viewer is viewing a video, that is, while the video is projected on the display surface by the projection device. Hereinafter, such a video processing method will be referred to as a “video processing method of a comparative example” and described.

In the video processing method of the comparative example, while a plurality of (here, four) subframes obtained by temporally dividing a frame included in video data is projected on the display surface, a first pattern image and a second pattern image are respectively superimposed on two subframes of the plurality of subframes. The first pattern image is an image including a predetermined pattern binarized in black and white. The second pattern image is an image in which luminance values of pixels of the first pattern image are inverted, that is, black and white of the predetermined pattern included in the first pattern image is inverted.

Hereinafter, a subframe on which the first pattern image is superimposed is also referred to as a “first superimposed subframe”, and a subframe on which the second pattern image is superimposed is also referred to as a “second superimposed subframe”. Here, assuming that the two subframes are the same original image, the first superimposed subframe is an image in which the first pattern image is superimposed on the original image, and the second superimposed subframe is an image in which the second pattern image is superimposed on the original image. The original image is an image on which no pattern image is superimposed among images included in the video data.

Then, in the video processing method of the comparative example, the imaging device captures the first superimposed subframe and the second superimposed subframe, and calculates a difference between the captured image of the first superimposed subframe and the captured image of the second superimposed subframe, to acquire a difference image. A shape of pattern of the difference image generally matches a shape of pattern of the first pattern image. This is because the original image can be removed by calculating the difference between the first superimposed subframe and the second superimposed subframe. Hereinafter, this difference image is also referred to as a “third pattern image”.

Thereafter, in the video processing method of the comparative example, the deviation of the display position of the video projected on the display surface is detected by comparing a feature point of the third pattern image with a reference feature point, and the deviation of the display position of the video is corrected according to a detection result. Note that detection of the deviation of the display position of the video and correction of the deviation of the display position of the video will be described in detail in [2. Configuration] described later.

Here, in order to accurately detect the deviation of the display position of the video, it is necessary to accurately detect pattern images from the first superimposed subframe and the second superimposed subframe captured by the imaging device. In order to accurately detect the pattern images, for example, it is conceivable to increase, for example, pixel values of the pattern images (here, the first pattern image and the second pattern image). However, when the pixel values of the pattern images are simply increased, each of the first superimposed subframe and the second superimposed subframe projected on the display surface tends to be an image deviated from the original image, and there is a problem that the pattern image is easily perceived by the viewer.

In view of the above, the inventor has created the present disclosure.

Hereinafter, embodiments of the present disclosure will be described with reference to the drawings. Note that the embodiments described below are all comprehensive or specific examples. Numerical values, shapes, materials, components, arrangement positions and connection modes of the components, steps, order of the steps, and the like shown in the following embodiments are merely examples, and are not intended to limit the present disclosure. Further, among the components in the following embodiments, components not recited in the independent claims are described as optional components.

Note that the drawings are schematic diagrams, and are not necessarily strictly shown. In the drawings, substantially the same components are denoted by the same reference numerals, and redundant description may be omitted or simplified.

### Embodiment

### 2. Configuration

### [2-1. Overall Configuration]

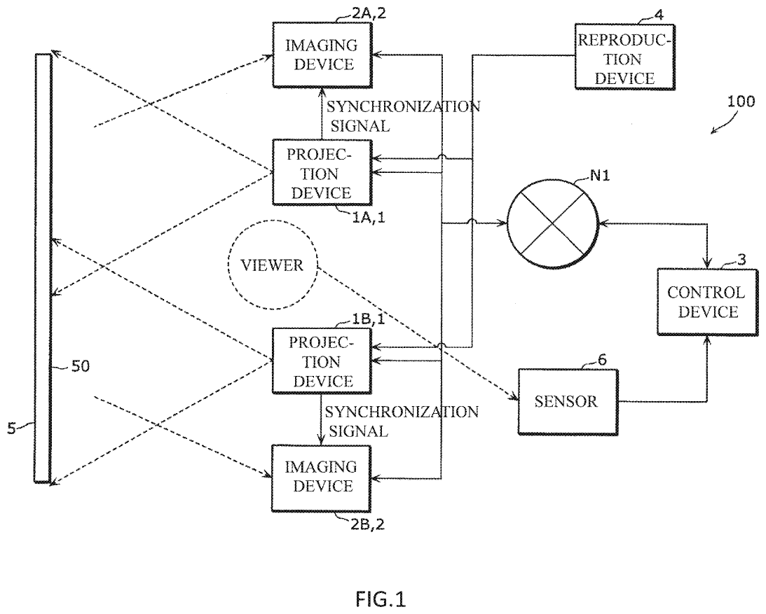

First, an overall configuration including a video processing system 100 according to an embodiment will be described. FIG. 1 is a block diagram showing the overall configuration including the video processing system 100 according to the embodiment. The video processing system 100 includes two projection devices 1A and 1B, two imaging devices 2A and 2B, and a control device 3. The video processing system 100 is a system that processes the video data transmitted from a reproduction device 4. Hereinafter, when the two projection devices 1A and 1B are not distinguished from each other, they are referred to as “projection device 1”. Further, hereinafter, when the two imaging devices 2A and 2B are not distinguished from each other, they are referred to as “imaging device 2”.

The projection device 1 is a device having a projector function, and projects the video onto a display surface 50 of a screen 5 based on the video data included in a video signal transmitted from the reproduction device 4. Note that projection device 1 is not limited to a mode of projecting the video on the display surface 50 of the screen 5, and may be a mode of projecting the video by using a surface of a structure other than the screen, such as a wall surface, as the display surface 50. In the embodiment, a composite video is projected on the display surface 50 by projecting videos respectively from the two projection devices 1A and 1B onto the display surface 50.

The imaging device 2 is a device having a camera function, and captures the video projected on the display surface 50. In the embodiment, the imaging device 2A captures the video projected on the display surface 50 by the projection device 1A. The imaging device 2B captures the video projected on the display surface 50 by the projection device 1B. In the embodiment, the imaging device 2 is a device different from the projection device 1, but may be built in the projection device 1. Specifically, the imaging devices 2A and 2B may be respectively built in the projection devices 1A and 1B.

The control device 3 is, for example, an information terminal such as a desktop or laptop personal computer, and controls the projection device 1 and the imaging device 2 by communicating with the projection device 1 and the imaging device 2 via a network N1 such as a local area network (LAN). Communication between the projection device 1 and the imaging device 2, and the control device 3 is performed according to a known network protocol such as a hypertext transfer protocol (HTTP), a file transfer protocol (FTP), or a transmission control protocol (TCP).

In the embodiment, the control device 3 is implemented by installing software dedicated to the video processing system 100 in a general-purpose information terminal. Note that the control device 3 is not limited to the general-purpose information terminal, but may be an information terminal dedicated to the video processing system 100. The information terminal is not limited to a personal computer, and may be realized by, for example, a smartphone, a tablet terminal, or the like.

The reproduction device 4 is a device having a function of reproducing a video recorded on an optical medium such as a digital versatile disc (DVD) (registered trademark) or a Blu-ray (registered trademark) disc (BD). Note that the reproduction device 4 may be a device having a function of reproducing a video recorded in a storage device such as a hard disc drive (HDD).

### [2-2. Projection Device]

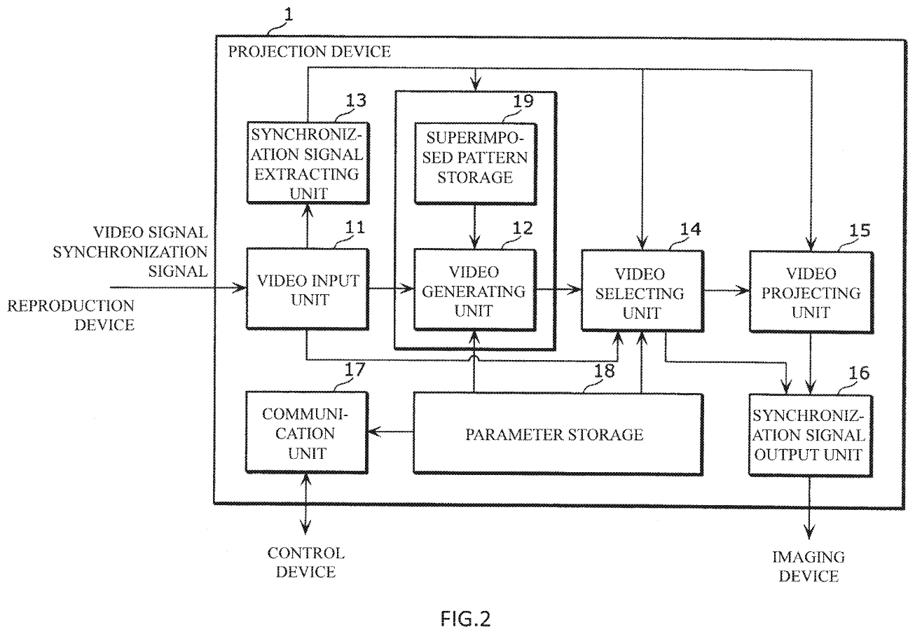

Next, a configuration of the projection device 1 will be described in detail. FIG. 2 is a block diagram showing the configuration of the projection device 1 according to the embodiment. As shown in FIG. 2, the projection device 1 includes a video input unit 11, a video generating unit 12, a synchronization signal extracting unit 13, a video selecting unit 14, a video projecting unit 15, a synchronization signal output unit 16, a communication unit 17, a parameter storage 18, and a superimposed pattern storage 19. The video input unit 11, the video generating unit 12, the synchronization signal extracting unit 13, the video selecting unit 14, the video projecting unit 15, the synchronization signal output unit 16, and the communication unit 17 may each be implemented by a dedicated circuit, or implemented by a processor executing a corresponding computer program stored in a memory.

The video input unit 11 acquires the video signal input from an outside (here, the reproduction device 4), and converts the acquired video signal into an internal video signal. Here, resolution and frame rate of the video signal are not particularly limited. That is, video signals having various resolutions or frame rates are input from the reproduction device 4 to the video input unit 11. In the embodiment, the internal video signal has 4K resolution, and the frame rate is a first frame rate (for example, 60 fps).

The video generating unit 12 performs various types of processing on the internal video signal from the video input unit 11. First, the video generating unit 12 performs embedding determination of determining whether a pattern image can be embedded in (superimposed on) the internal video signal. In the embodiment, the pattern image is embedded in a blue signal having relatively low brightness sensitivity for humans in the internal video signal. In other words, the pattern images (first pattern image PP1 and second pattern image PP2 to be described later) are both superimposed on the video signal of a blue component. Therefore, in the embodiment, the video generating unit 12 performs the embedding determination on the blue signal in the internal video signal.

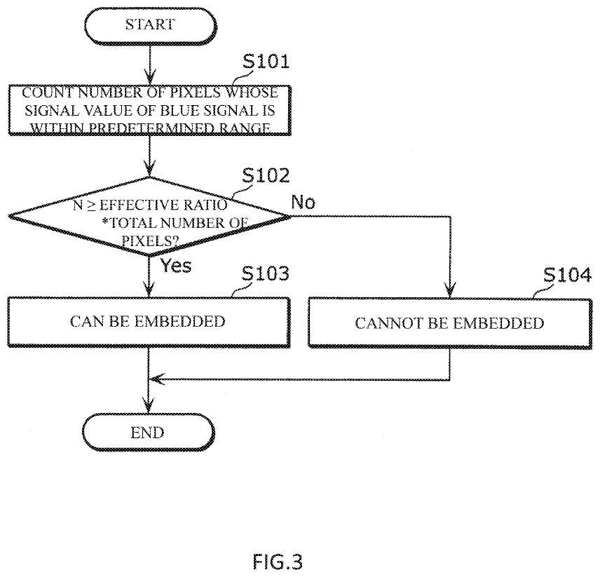

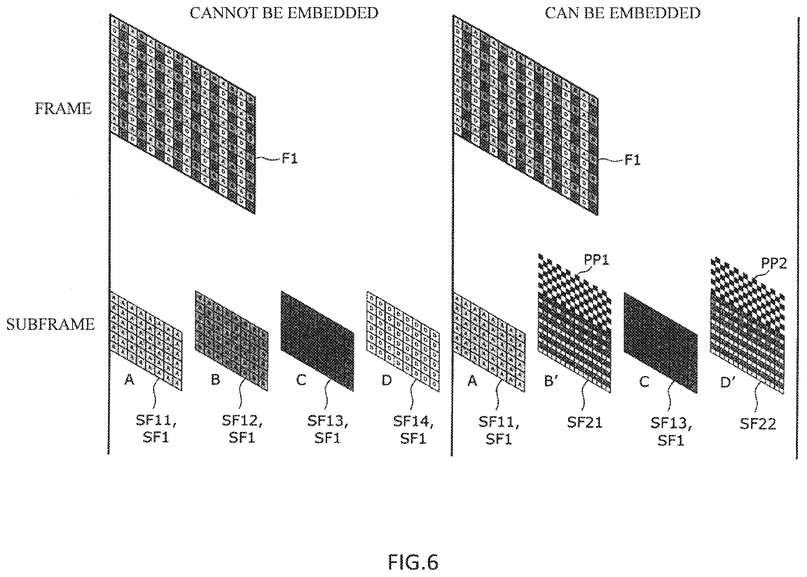

Hereinafter, the embedding determination will be described with reference to FIG. 3. FIG. 3 is a flowchart showing an example of the embedding determination. The embedding determination described below is performed for each frame F1 (see FIG. 6 described later).

First, the video generating unit 12 counts the number of pixels N whose signal value (pixel value) of the blue signal is within a predetermined range in the internal video signal (S101). Here, the predetermined range is a range between an upper limit value and a lower limit value of the signal value of the blue signal that is a parameter stored in the parameter storage 18. When the signal value of the blue signal is within the predetermined range, it is possible to embed the pattern image by increasing or decreasing the signal value of the blue signal. On the other hand, when the signal value of the blue signal is out of the predetermined range, the blue signal is saturated when the signal value of the blue signal is increased or decreased, and the pattern image cannot be embedded.

Next, the video generating unit 12 compares the number of pixels N counted with a value obtained by multiplying the number of all pixels included in the frame F1 by an effective ratio (S102). Here, the effective ratio is a parameter stored in the parameter storage 18 and represents a pixel ratio in which the pattern image can be embedded among all pixels of the frame F1. Then, if the number of pixels N is equal to or larger than a value obtained by multiplying the total number of pixels by the effective ratio (S102: Yes), the video generating unit 12 determines that the pattern image can be embedded in the frame F1 (S103). On the other hand, if the number of pixels N is less than the value obtained by multiplying the total number of pixels by the effective ratio (S102: No), the video generating unit 12 determines that the pattern image cannot be embedded in the frame F1 (S104).

Note that when an embedding mode is “valid”, the video generating unit 12 executes steps S101 to S104 described above. When the embedding mode is “invalid”, the video generating unit 12 executes step S104 without executing steps S101 and S102 described above. When the embedding mode is “forced”, the video generating unit 12 executes step S103 without executing steps S101 and S102 described above. Here, the embedding mode is a parameter stored in the parameter storage 18.

Secondly, the video generating unit 12 geometrically corrects the internal video signal according to a look up table (LUT) for geometric correction. This process corrects the deviation of the display position of the video projected from the projection device 1 onto the display surface 50. Here, the LUT for geometric correction is a parameter stored in the parameter storage 18.

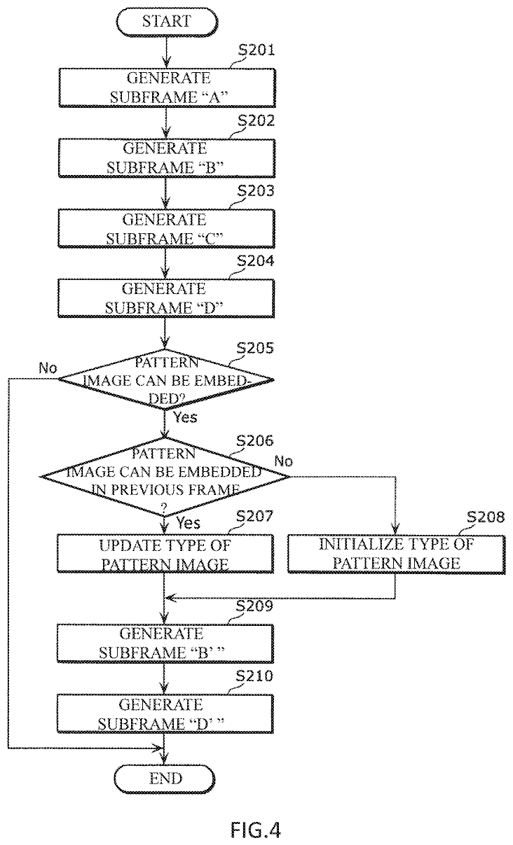

Third, the video generating unit 12 generates a plurality of subframes SF1 (see FIG. 6 described later) obtained by temporally dividing the frame F1. Hereinafter, the generation process will be described with reference to FIG. 4. FIG. 4 is a flowchart showing an example of the generation process of the plurality of subframes SF1. The generation process described below is performed for each frame F1.

First, the video generating unit 12 generates a subframe “A” (that is, a subframe SF11) by extracting odd-numbered pixels from among pixels in an X-direction (a horizontal direction) of the frame F1 and odd-numbered pixels from among pixels in a Y-direction (vertical direction) of the frame F1 (S201). The video generating unit 12 generates a subframe “B” (that is, a subframe SF12) by extracting even-numbered pixels from among the pixels in the X-direction of the frame F1 and odd-numbered pixels from among the pixels in the Y-direction of the frame F1 (S202). The video generating unit 12 generates a subframe “C” (that is, a subframe SF13) by extracting even-numbered pixels from among the pixels in the X-direction of the frame F1 and even-numbered pixels from among the pixels in the Y-direction of the frame F1 (S203). The video generating unit 12 generates a subframe “D” (that is, a subframe SF14) by extracting odd-numbered pixels from among the pixels in the X-direction of the frame F1 and even-numbered pixels from among the pixels in the Y-direction of the frame F1 (S204).

Each of the plurality of subframes SF1 is an image including only subpixels of the same phase in each pixel of the frame F1. For example, when each pixel of the frame F1 includes four subpixels of “A”, “B”, “C”, and “D”, each pixel of the subframe “A” includes only the subpixel “A” of a corresponding pixel in the frame F1.

Next, the video generating unit 12 refers to a result of the embedding determination in the frame F1 (S205). If the result of the embedding determination indicates that the pattern image cannot be embedded (S205: No), the video generating unit 12 stops generating. On the other hand, if the determination result of the embedding determination indicates that the pattern image can be embedded (S205: Yes), the video generating unit 12 performs determination of the type of the pattern image to be embedded in the frame F1.

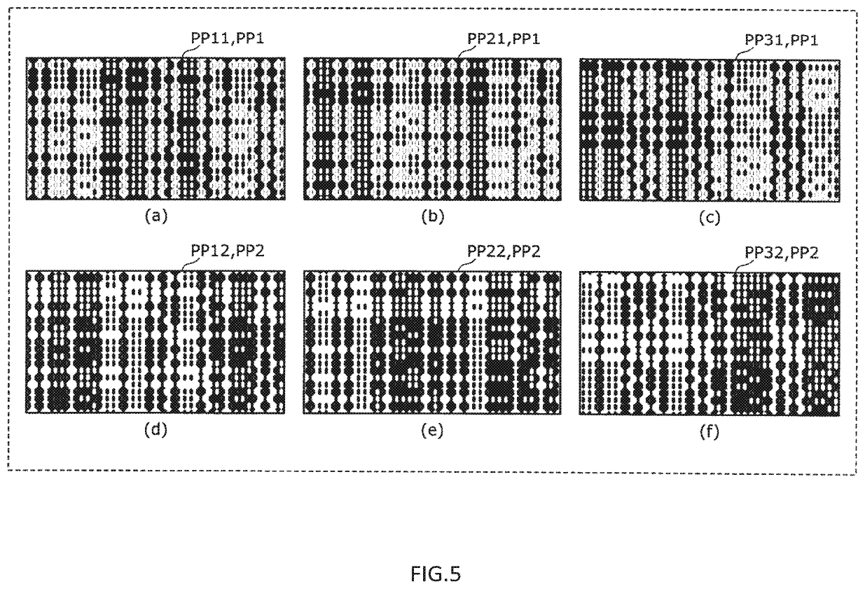

FIG. 5 is a diagram showing an example of the pattern image. (a) to (c) of FIG. 5 show the first pattern image PP1, and (d) to (f) of FIG. 5 show the second pattern image PP2. Specifically, (a) of FIG. 5 shows a first pattern image PP11 for a red (R) channel, (b) of FIG. 5 shows a first pattern image PP21 for a green (G) channel, and (c) of FIG. 5 shows a first pattern image PP31 for a blue (B) channel. (d) of FIG. 5 shows a second pattern image PP12 for the R channel, (e) of FIG. 5 shows a second pattern image PP22 for the G channel, and (f) of FIG. 5 shows a second pattern image PP32 for the B channel.

In the embodiment, the video generating unit 12 sequentially embeds the first pattern image PP11 and the second pattern image PP12 for the R channel, the first pattern image PP21 and the second pattern image PP22 for the G channel, and the first pattern image PP31 and the second pattern image PP32 for the B channel for each frame F1.

Returning to FIG. 4, the video generating unit 12 refers to the result of the embedding determination in a previous frame of the frame F1 (S206). Then, if the pattern image can be embedded in the previous frame (S206: Yes), the video generating unit 12 updates the type of the pattern image to be embedded (S207). For example, when the first pattern image PP11 and the second pattern image PP12 for the R channel are embedded in the previous frame, the video generating unit 12 determines the pattern image to be embedded in the frame F1 as the first pattern image PP11 and the second pattern image PP12 for the G channel.

On the other hand, if the pattern image cannot be embedded in the previous frame (S206: No), the video generating unit 12 initializes the type of the pattern image to be embedded (S208). Here, initialization means that the pattern image to be embedded in the frame F1 is determined as the first pattern image PP11 and the second pattern image PP12 for the R channel.

In this way, the video generating unit 12 embeds the first pattern image PP11 and the second pattern image PP12 for the R channel in the frame F1 starting from the frame F1 in which the pattern image has changed from not being embeddable to being embeddable. Then, as long as the determination result of being embeddable continues, the video generating unit 12 sequentially embeds the first pattern image PP11 and the second pattern image PP12 for the R channel, the first pattern image PP11 and the second pattern image PP12 for the G channel, and the first pattern image PP11 and the second pattern image PP12 for the B channel for each frame F1.

Next, the video generating unit 12 generates the subframe “B′” (S209). Here, the subframe “B′” is an image in which the first pattern image PP1 is embedded in (superimposed on) a composite image obtained by combining the subframe “B” and the subframe “D”. Specifically, in each pixel of the composite image, the video generating unit 12 adds the signal value of the blue signal of a pixel corresponding to white of the first pattern image PP1 by an embedding signal value α, and subtracts the signal value of the blue signal of a pixel corresponding to black of the first pattern image PP1 by the embedding signal value α, to generate the subframe “B′”. Here, the embedding signal value α is a parameter stored in the parameter storage 18.

Next, the video generating unit 12 generates the subframe “D′” (S210). Here, the subframe “D′” is an image in which the second pattern image PP2 is embedded in (superimposed on) the composite image obtained by combining the subframe “B” and the subframe “D”. Specifically, in each pixel of the composite image, the video generating unit 12 adds the signal value of the blue signal of a pixel corresponding to white of the second pattern image PP2 by the embedding signal value α, and subtracts the signal value of the blue signal of a pixel corresponding to black of the second pattern image PP2 by the embedding signal value α, to generate the subframe “D′”.

The subframe “B′” corresponds to a first superimposed subframe SF21 (see FIG. 6 described later), and the subframe “D′” corresponds to a second superimposed subframe SF22 (see FIG. 6 described later). Then, the composite image obtained by combining the subframe “B” and the subframe “D” corresponds to a “first subframe” and also corresponds to a “second subframe”.

As described above, in the embodiment, the first superimposed subframe SF21 is an image in which the first pattern image PP1 is superimposed on the first subframe (here, the composite image) based on the plurality of subframes SF1. The second superimposed subframe SF22 is an image in which the second pattern image PP2 is superimposed on the second subframe (here, the composite image) based on the plurality of subframes SF1. Then, both the first subframe and the second subframe are images obtained by combining two subframes (here, subframes “B” and “D”) of the plurality of subframes SF1, and are the same image. On the other hand, both the subframes SF11 and SF13 on which neither the first pattern image PP1 nor the second pattern image PP2 is superimposed are images different from both the first superimposed subframe SF21 and the second superimposed subframe SF22.

Based on a synchronization signal input together with the video signal from the outside (here, the reproduction device 4), the synchronization signal extracting unit 13 generates an internal synchronization signal of the same frame rate (here, 60 fps) as the frame rate of the internal video signal. The internal synchronization signal is given to each of the video generating unit 12, the video selecting unit 14, and the video projecting unit 15. The video generating unit 12, the video selecting unit 14, and the video projecting unit 15 operate for each frame based on the internal synchronization signal.

The video selecting unit 14 selects a subframe set of the video to be projected on the display surface 50 from the video projecting unit 15 according to the result of the embedding determination in the frame F1 in the video generating unit 12. Here, the subframe set includes the plurality of subframes SF1 corresponding to the frame F1.

FIG. 6 is an explanatory diagram of an operation example of the video selecting unit 14 of the projection device 1 according to the embodiment. As shown in FIG. 6, when the result of the embedding determination in the frame F1 indicates that the pattern image cannot be embedded, the video selecting unit 14 selects a subframe set including subframes “A”, “B”, “C”, and “D”. Here, the subframes “A”, “B”, “C”, and “D” respectively correspond to the subframes SF11, SF12, SF13, and SF14.

On the other hand, as shown in FIG. 6, when the result of the embedding determination in the frame F1 indicates that the pattern image can be embedded, the video selecting unit 14 selects a subframe set including subframes “A”, “B′”, “C”, and “D′”. Here, the subframes “A”, “B′”, “C”, and “D′” respectively correspond to the subframe SF11, the first superimposed subframe SF21, the subframe SF13, and the second superimposed subframe SF22.

As described above, in the embodiment, the video selecting unit 14 selects the subframe set to be output to the display surface 50 according to the result of the embedding determination in the video generating unit 12. Further, as described above, in the embedding determination, it is determined whether it is possible to embed the pattern image with reference to the signal value of the blue signal in the internal video signal for each frame F1. That is, the video processing system 100 according to the embodiment determines whether to output the first superimposed subframe SF21 and the second superimposed subframe SF22 to the display surface 50 based on the pixel value (here, the signal value of the blue signal) of the video signal in the frame F1.

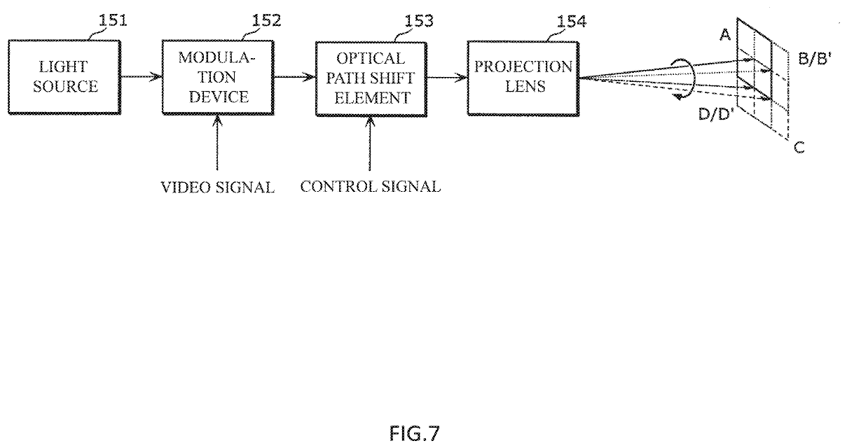

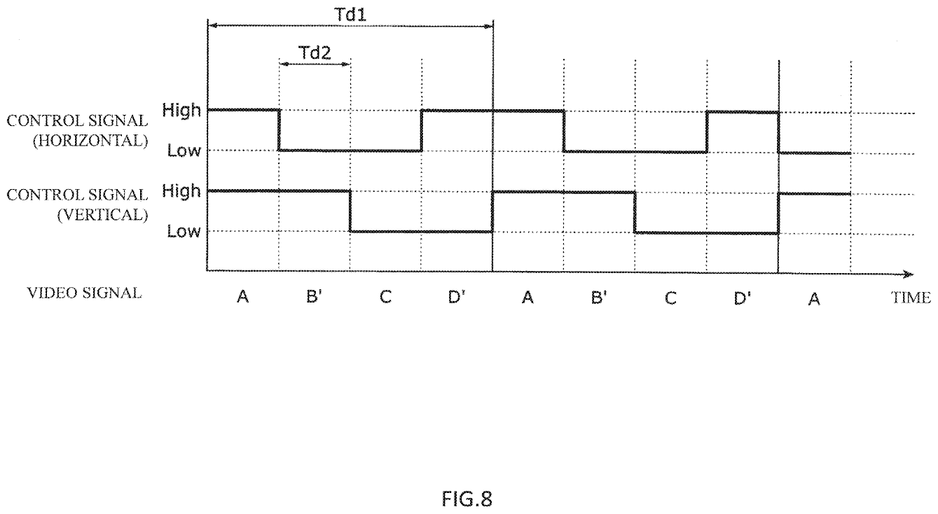

The video projecting unit 15 projects the video onto the display surface 50 according to the video signal of the subframe set selected by the video selecting unit 14. Hereinafter, a specific configuration and operation of the video projecting unit 15 will be described with reference to FIGS. 7 and 8. FIG. 7 is a schematic diagram of the video projecting unit 15 of the projection device 1 according to the embodiment. FIG. 8 is a diagram showing a correlation between a control signal given to an optical path shift element 153 and the video signal.

As shown in FIG. 7, the video projecting unit 15 includes a light source 151, a modulation device 152, the optical path shift element 153, and a projection lens 154.

The light source 151 has, for example, an ultra-high pressure mercury lamp or a metal halide lamp, and outputs parallel light to the modulation device 152.

The modulation device 152 modulates light output from the light source 151 according to the video signal input, and outputs the modulated light to the optical path shift element 153.

The optical path shift element 153 is made of, for example, translucent parallel plate glass, and is inclined according to a signal voltage of the control signal. An optical path of light incident on the optical path shift element 153 is shifted according to an inclination of the optical path shift element 153. In the embodiment, the control signal includes a horizontal control signal and a vertical control signal. Therefore, the optical path shift element 153 can be inclined in both the horizontal direction and the vertical direction according to the signal voltage of the control signal.

The projection lens 154 condenses the light output from the optical path shift element 153 and outputs the light to the display surface 50, and forms an image corresponding to the light output from the optical path shift element 153 on the display surface 50.

In the embodiment, by using a pixel shift technique, subframes SF1 included in the subframe set selected by the video selecting unit 14 are sequentially projected on the display surface 50 while being shifted by half a pixel at a second frame rate (here, 240 fps). Here, as shown in FIG. 8, both the horizontal control signal and the vertical control signal are both rectangular wave signals that alternately repeat a high level and a low level in a first period Td1 (here, 1/120 seconds). Then, the horizontal control signal and the vertical control signal are shifted from each other by ¼ of the first period Td1. Therefore, combination of the signal voltage of the horizontal control signal and the signal voltage of the vertical control signal changes in a second period Td2 (here, 1/240 seconds).

For example, the video projecting unit 15 projects the light corresponding to the subframe “A” onto the display surface 50 at a timing when the horizontal control signal is the high level and the vertical control signal is the high level. Thus, the subframe “A” is projected on the display surface 50.

Further, the video projecting unit 15 projects the light corresponding to the subframe “B” or the subframe “B′” on the display surface 50 at a timing when the horizontal control signal is the low level and the vertical control signal is the high level. Thus, the subframe “B” or the subframe “B′” is projected on the display surface 50 at a position shifted by half a pixel in the horizontal direction from a display position of the subframe “A”.

Further, the video projecting unit 15 projects the light corresponding to the subframe “C” on the display surface 50 at a timing when the horizontal control signal is the low level and the vertical control signal is the low level. Thus, the subframe “C” is projected on the display surface 50 at a position shifted by half a pixel in the horizontal direction and half a pixel in the vertical direction from the display position of the subframe “A”.

Further, the video projecting unit 15 projects the light corresponding to the subframe “D” or the subframe “D′” on the display surface 50 at a timing when the horizontal control signal is the high level and the vertical control signal is the low level. Thus, the subframe “D” or the subframe “D′” is projected on the display surface 50 at a position shifted by half a pixel in the vertical direction from the display position of the subframe “A”.

In this way, the video processing system 100 according to the embodiment sequentially projects the plurality of subframes SF1 (here, subframe “A”, subframe “B” (or “B′”), subframe “C”, subframe “D” (or “D′”)) on the display surface 50 by using the pixel shift technique. Thus, the video processing system 100 according to the embodiment projects the video on the display surface 50 with a resolution (here, 4K resolution) higher than a resolution (here, the resolution is 2K) that can be supported by the modulation device 152 of the projection device 1.

The synchronization signal output unit 16 outputs the synchronization signal to the imaging device 2. The synchronization signal is a pulse signal that goes to the high level at a timing when the first superimposed subframe SF21 and the second superimposed subframe SF22 are projected on the display surface 50. Note that when the first superimposed subframe SF21 and the second superimposed subframe SF22 are not included in the subframe set selected by the video selecting unit 14, the synchronization signal output unit 16 does not output the synchronization signal to the imaging device 2.

The communication unit 17 is a communication interface for communicating with the control device 3 via the network N1. The communication unit 17 receives a parameter setting command transmitted from the control device 3, and changes various parameters stored in the parameter storage 18 according to content of the received parameter setting command. Note that communication between the communication unit 17 and the control device 3 may be wired communication or wireless communication.

The parameter storage 18 is a semiconductor memory or the like, and stores various parameters to be referred to when the projection device 1 operates. In the embodiment, the parameter storage 18 stores the upper limit value and the lower limit value of the signal value of the blue signal, the effective ratio, the embedding signal value α, and the embedding mode, which are parameters referred to in the embedding determination described above. In addition, the parameter storage 18 stores the LUT for geometric correction described above. Note that these parameters are examples, and the parameter storage 18 may further store other parameters.

The superimposed pattern storage 19 is a semiconductor memory or the like, and stores bitmap data of the pattern images (first pattern image PP1 and second pattern image PP2) to be superimposed on the subframe SF1. Note that the parameter storage 18 and the superimposed pattern storage 19 may be realized by the same semiconductor memory. Note that the superimposed pattern storage 19 may be implemented such that the bitmap data of the pattern images (first pattern image PP1 and second pattern image PP2) to be superimposed on the subframe SF1 is generated by a programmable logic circuit such as an FPGA each time.

### [2-3. Imaging Device]

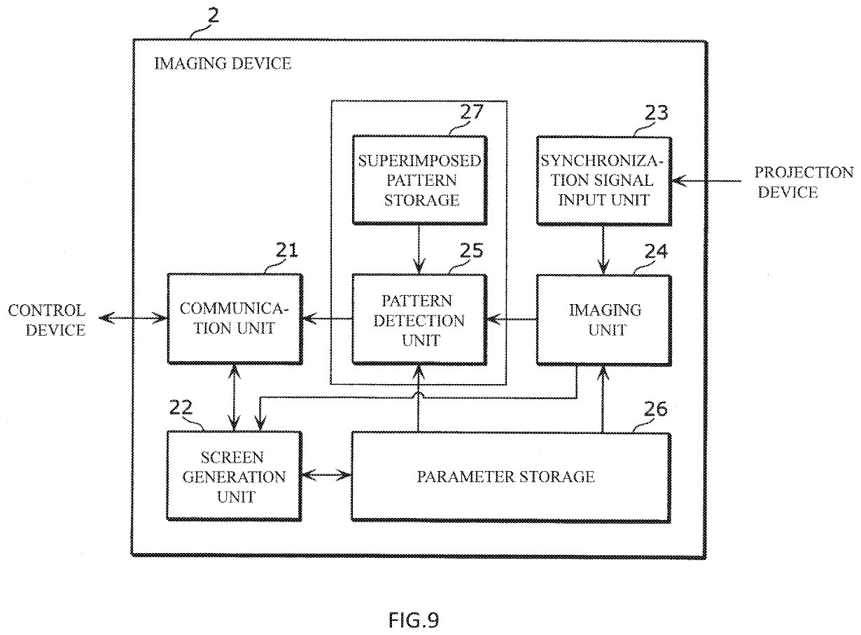

Next, a configuration of the imaging device 2 will be described in detail. FIG. 9 is a block diagram showing the configuration of the imaging device 2 according to the embodiment. As shown in FIG. 9, the imaging device 2 includes a communication unit 21, a screen generation unit 22, a synchronization signal input unit 23, an imaging unit 24, a pattern detection unit 25, a parameter storage 26, and a superimposed pattern storage 27. The communication unit 21, the screen generation unit 22, the synchronization signal input unit 23, the imaging unit 24, and the pattern detection unit 25 may each be implemented by a dedicated circuit, or implemented by a processor executing a corresponding computer program stored in the memory.

The communication unit 21 is a communication interface for communicating with the control device 3 via the network N1. The communication unit 21 receives a command transmitted from the control device 3, and relays the received command to the screen generation unit 22. Further, the communication unit 21 transmits a result of processing performed by the screen generation unit 22 to the control device 3. Note that communication between the communication unit 21 and the control device 3 may be wired communication or wireless communication.

The screen generation unit 22 generates a screen to be displayed on a display attached to the control device 3 by a screen display unit 32 (described later) of the control device 3. In the embodiment, the screen generation unit 22 generates an HTML page according to the command from the control device 3. For example, in response to the command from the control device 3, the screen generation unit 22 generates the HTML page including current various parameters of the imaging device 2 and an icon for accepting changes in the various parameters. Further, for example, the screen generation unit 22 changes various parameters of the imaging device 2 or starts or stops imaging by the imaging unit 24 in response to a command from the control device 3, and generates the HTML page including the result.

The synchronization signal input unit 23 receives the synchronization signal transmitted from the projection device 1, and provides the received synchronization signal to the imaging unit 24.

The imaging unit 24 captures an image projected on the display surface 50. In the embodiment, the imaging unit 24 starts exposure at a timing corresponding to a trigger mode. Here, the trigger mode is a parameter stored in the parameter storage 26. When the trigger mode is the “synchronization signal”, the imaging unit 24 starts exposure at a timing when a pulse of the synchronization signal from the projection device 1 rises. That is, in this case, the imaging unit 24 captures only the first superimposed subframe SF21 and the second superimposed subframe SF22 in the video projected on the display surface 50. Further, when the trigger mode is “program”, the imaging unit 24 receives a command to start imaging from the control device 3 and starts exposure.

Note that a time from start to end of the exposure of the imaging unit 24 is determined by an exposure time (here, the unit is millisecond) stored in the parameter storage 26. Further, when a trigger delay amount (here, the unit is microsecond) stored in the parameter storage 26 is not zero, the imaging unit 24 starts exposure delayed by the trigger delay amount after the pulse of the synchronization signal rises.

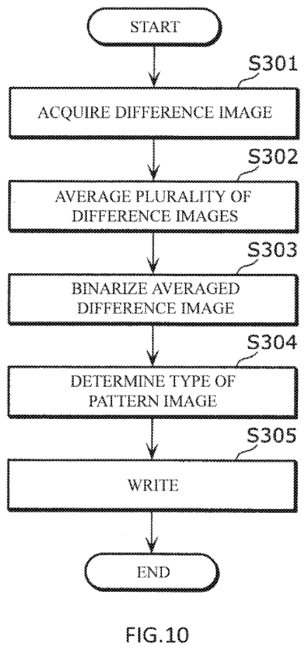

The pattern detection unit 25 detects the pattern image from the first superimposed subframe SF21 and the second superimposed subframe SF22 captured by the imaging unit 24. Hereinafter, the detection will be described with reference to FIG. 10. FIG. 10 is a flowchart showing an example of pattern image detection. The detection described below is performed every time the first superimposed subframe SF21 and the second superimposed subframe SF22 are imaged by the imaging unit 24.

First, the pattern detection unit 25 acquires the difference image by calculating a difference between the first superimposed subframe SF21 and the second superimposed subframe SF22 captured by the imaging unit 24 (S301). Note that a display position of the first superimposed subframe SF21 and a display position of the second superimposed subframe SF22 on the display surface 50 are shifted from each other by a shift amount by the optical path shift element 153 because the pixel shift technique is used in the video projecting unit 15 of the projection device 1. Therefore, the pattern detection unit 25 calculates the difference after shifting one of the first superimposed subframe SF21 and the second superimposed subframe SF22 by the shift amount.

Here, the difference image acquired in step S301 is any one of the pattern image for the R channel, the pattern image for the G channel, and the pattern image for the B channel. For example, when the first pattern image PP11 and the second pattern image PP12 for the R channel are embedded in the frame F1 in the projection device 1, the pattern detection unit 25 acquires the pattern image for the R channel while the video corresponding to the frame F1 is projected on the display surface 50.

Next, the pattern detection unit 25 averages a plurality of the difference images (S302). Here, the pattern detection unit 25 sequentially acquires the difference images corresponding to the pattern image for the R channel, the difference image corresponding to the pattern image for the G channel, and the difference image corresponding to the pattern image for the B channel for each frame F1. Therefore, as long as the pattern image is embedded in each frame F1 in the projection device 1, the pattern detection unit 25 can acquire the difference image corresponding to the pattern image for the same channel every three frames. Therefore, the pattern detection unit 25 averages the plurality of difference images at the time of acquiring a predetermined number (for example, 10 sheets) of difference images in each of the R channel, the G channel, and the B channel. Thus, noise included in the averaged difference image can be reduced.

Next, the pattern detection unit 25 binarizes the averaged difference image (S303). Here, since both the first superimposed subframe SF21 and the second superimposed subframe SF22 captured by the imaging unit 24 are color images, the averaged difference image is also a color image. Therefore, the pattern detection unit 25 binarizes the averaged difference image to acquire the difference image binarized in black and white.

Next, the pattern detection unit 25 determines the type of the pattern image by pattern matching between the difference image binarized in black and white and template of the pattern image for the R channel, template of the pattern image for the G channel, and template of the pattern image for the B channel stored by the superimposed pattern storage 27 (S304). For example, when the difference image binarized in black and white substantially coincides with the template of the pattern image for the G channel, the pattern detection unit 25 determines that the difference image is the pattern image for the G channel.

Then, the pattern detection unit 25 writes the difference image in which the type of the pattern image is determined in the memory as a third pattern image PP3 (S305). By repeating steps S301 to S305, the imaging device 2 acquires the third pattern image PP3 for the R channel, the third pattern image PP3 for the G channel, and the third pattern image PP3 for the B channel.

The parameter storage 26 is a semiconductor memory or the like, and stores various parameters to be referred to when the imaging device 2 operates. In the embodiment, the parameter storage 26 stores the trigger mode, the exposure time, and the trigger delay amount described above. Note that these parameters are examples, and the parameter storage 26 may further store other parameters.

The superimposed pattern storage 27 is a semiconductor memory or the like, and stores bitmap data of the template of the pattern image for the R channel, the template of the pattern image for the G channel, and the template of the pattern image for the B channel used in the detection described above. Note that the parameter storage 26 and the superimposed pattern storage 27 may be realized by the same semiconductor memory.

### [2-4. Control Device]

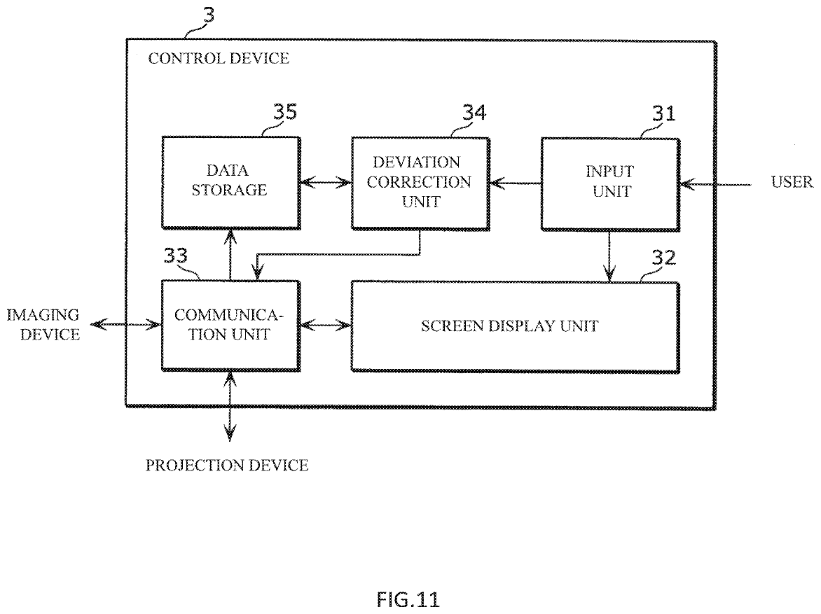

Next, a configuration of the control device 3 will be described in detail. FIG. 11 is a block diagram showing the configuration of the control device 3 according to the embodiment. As shown in FIG. 11, the control device 3 includes an input unit 31, a screen display unit 32, a communication unit 33, a deviation correction unit 34, and a data storage 35. The input unit 31, the screen display unit 32, the communication unit 33, and the deviation correction unit 34 may each be implemented by a dedicated circuit, or implemented by a processor executing a corresponding computer program stored in the memory.

The input unit 31 receives an input by a user using a pointing device such as a keyboard or a mouse. The input unit 31 gives a control command corresponding to the input from the user to the projection device 1 or the imaging device 2. The control command includes, for example, an instruction to change various parameters of the imaging device 2, an instruction to transmit various parameters of the imaging device 2, an instruction to transmit the third pattern image PP3 from the imaging device 2, an instruction to initialize deviation correction by the deviation correction unit 34 described later, or an instruction to start or end the deviation correction by the deviation correction unit 34.

The screen display unit 32 displays a user interface (UI) screen for operating the control device 3 on the display attached to the control device 3. For example, the screen display unit 32 displays the HTML page or the like generated by the screen generation unit 22 of the imaging device 2 on the display.

The communication unit 33 is a communication interface for communicating with each of the projection device 1 and the imaging device 2 via the network N1. The communication unit 33 transmits the control command to the projection device 1 or the imaging device 2. Further, the communication unit 33 transmits LUT data for geometric correction after correction by the deviation correction described later to the projection device 1. Note that communication between the communication unit 33 and the projection device 1 and communication between the communication unit 33 and the imaging device 2 may be wired communication or wireless communication.

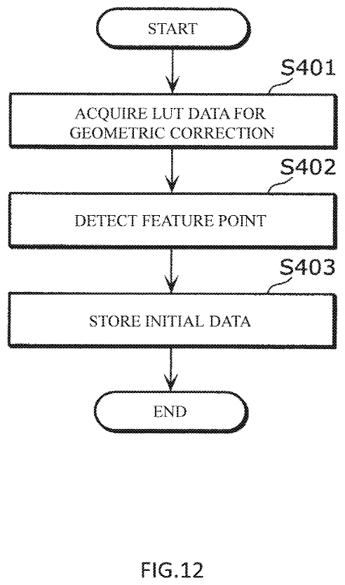

The deviation correction unit 34 has a function of performing initialization of the deviation correction. Hereinafter, the initialization of the deviation correction will be described with reference to FIG. 12. FIG. 12 is a flowchart showing an example of the initialization of the deviation correction. The initialization of the deviation correction only needs to be performed once according to the input from the user received by the input unit 31 before performing the deviation correction, for example, when use of the video processing system 100 is started.

First, the deviation correction unit 34 acquires the LUT data for geometric correction from the projection device 1 (S401). Next, the deviation correction unit 34 acquires the third pattern image PP3 for the R channel, the third pattern image PP3 for the G channel, and the third pattern image PP3 for the B channel from the imaging device 2, and detects a feature point SP1 of the third pattern image PP3 from these images (S402).

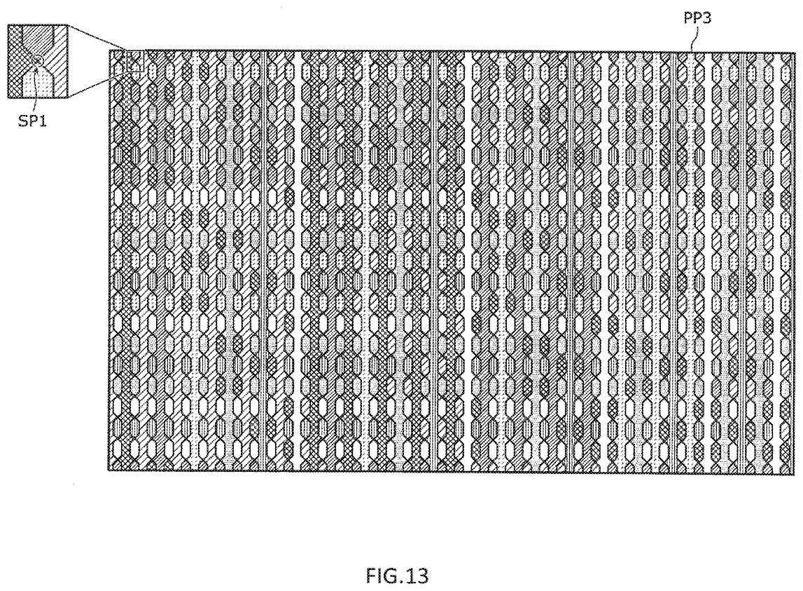

Hereinafter, a method for detecting the feature point SP1 of the third pattern image PP3 will be described with reference to FIG. 13. FIG. 13 is a diagram showing an example of the feature point SP1 of the third pattern image PP3. FIG. 13 shows the third pattern image PP3 obtained by synthesizing the third pattern image PP3 for the R channel, the third pattern image PP3 for the G channel, and the third pattern image PP3 for the B channel. Here, white pixels in the third pattern image PP3 for the R channel are used as red, white pixels in the third pattern image PP3 for the G channel are used as green, and white pixels in the third pattern image PP3 for the B channel are used as blue, to synthesize third pattern images PP3 for channels.

In FIG. 13, pixels are color-coded by the type of hatching. Here, the feature point SP1 is an intersection of four regions, and a point at which a color of an upper region, a color of a lower region, a color of a right region, and a color of a left region are different from each other. In particular, in a composite third pattern image PP3, there is only one point where the color of the upper region, the color of the lower region, the color of the right region, and the color of the left region form a specific combination. In the embodiment, the deviation correction unit 34 detects, as the feature point SP1, the intersection of the four regions in which a combination of colors is the specific combination.

Returning to FIG. 12, the deviation correction unit 34 stores data in which each point of the LUT for geometric correction is associated with the feature point SP1 of the detected third pattern image PP3 in the data storage 35 as initial data (S403).

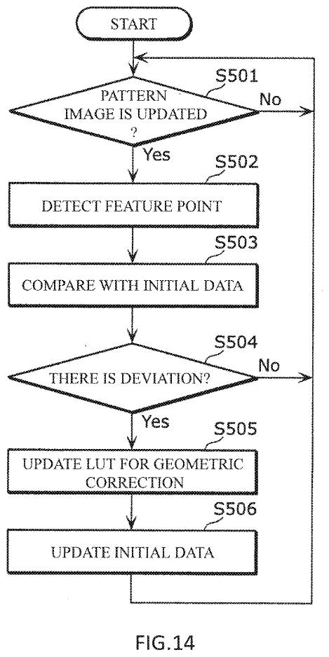

In addition, the deviation correction unit 34 has a function of performing the deviation correction. Hereinafter, the deviation correction will be described with reference to FIG. 14. FIG. 14 is a flowchart showing an example of the deviation correction.

First, the deviation correction unit 34 stands by until the pattern image (third pattern image PP3 for each channel) acquired from the imaging device 2 is updated (S501: No). Then, if the pattern image acquired from the imaging device 2 is updated (S501: Yes), the deviation correction unit 34 detects the feature point SP1, based on the acquired third pattern image PP3 for each channel (S502). Since the method for detecting the feature point SP1 has already been described, a description thereof will be omitted here.

Next, the deviation correction unit 34 compares the detected feature point SP1 with the feature point SP1 included in the initial data (S503). Here, the deviation correction unit 34 compares XY plane coordinates of the detected feature point SP1 with XY plane coordinates of the feature point SP1 included in the initial data.

As a result of comparison, if there is no deviation in position of the feature point SP1 (S504: No), the deviation correction unit 34 does not update the LUT for geometric correction and the initial data. On the other hand, if there is deviation in the position of the feature point SP1 (S504: Yes), the deviation correction unit 34 generates the LUT for geometric correction in which the deviation is zero, and updates the LUT for geometric correction (S505). In addition, the deviation correction unit 34 updates the initial data using the updated LUT for geometric correction (S506). Specifically, the deviation correction unit 34 updates the detected feature point SP1 as the feature point SP1 included in the initial data.

At this time, the deviation correction unit 34 transmits the updated (corrected) LUT data for geometric correction to the projection device 1 via the communication unit 33 and the network N1. Thereafter, the projection device 1 geometrically corrects the internal video signal according to the acquired corrected LUT for geometric correction. This makes it possible to correct the deviation of the display position of the video on the display surface 50.

The data storage 35 is a semiconductor memory or the like, and stores the initial data including the LUT data for geometric correction acquired from the imaging device 2, the third pattern image PP3 for each channel acquired from the imaging device 2, and the like.

### 3. Operation

Hereinafter, overall operation of the video processing system 100 according to the embodiment, that is, the video processing method according to the embodiment will be described.

### [3-1. Deviation Correction]

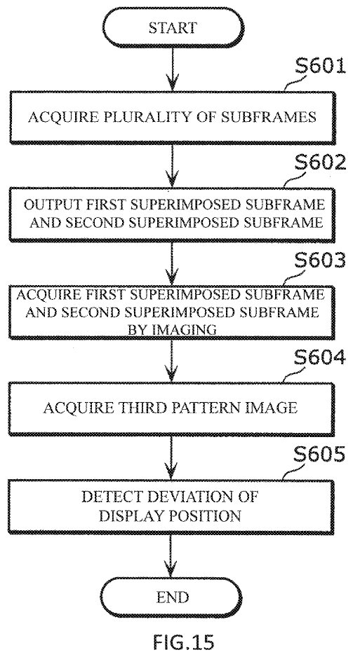

First, an operation example of deviation correction of the video processing system 100 according to the embodiment will be described with reference to FIG. 15. FIG. 15 is a flowchart showing the operation example of the deviation correction of the video processing system 100 according to the embodiment.

First, the video processing system 100 acquires the plurality of subframes SF1 obtained by temporally dividing the frame F1 included in the video data (S601). In the embodiment, an entity executing step S601 is the video generating unit 12 of the projection device 1.

Next, the video processing system 100 outputs the first superimposed subframe SF21 and the second superimposed subframe SF22 so as to be displayed on the display surface 50 (S602). The first superimposed subframe SF21 is an image in which the first pattern image PP1 is superimposed on the first subframe based on the plurality of subframes SF1. The second superimposed subframe SF22 is an image obtained by superimposing the second pattern image PP2 obtained by inverting the pixel value of the first pattern image PP1 on the second subframe based on the plurality of subframes SF1. In the embodiment, entities executing step S602 are the video generating unit 12, the video selecting unit 14, and the video projecting unit 15 of the projection device 1.

Next, the video processing system 100 acquires the first superimposed subframe SF21 and the second superimposed subframe SF22 displayed on the display surface 50 by imaging (step S603). In the embodiment, entities executing step S603 are the imaging unit 24 and the pattern detection unit 25 of the imaging device 2.

Next, the video processing system 100 acquires the third pattern image PP3 from the difference between the acquired first superimposed subframe SF21 and second superimposed subframe SF22 (step S604). In the embodiment, an entity executing step S604 is the pattern detection unit 25 of the imaging device 2.

Then, the video processing system 100 detects the deviation of the display position of the video projected on the display surface 50 by comparing the feature point SP1 of the acquired third pattern image PP3 with the reference feature point (S605). Here, the reference feature point is the feature point SP1 of the third pattern image PP3 included in the above-described initial data. In the embodiment, an entity executing step S605 is the deviation correction unit 34 of the control device 3.

Note that in the embodiment, the video processing system 100 updates the LUT for geometric correction in order to correct the detected deviation of the display position, but the update may not be performed.

### [3-2. Adjusting]

Next, an operation example of adjusting by the video processing system 100 according to the embodiment will be described. Adjusting is processing of increasing or decreasing a degree (hereinafter, also simply referred to as “degree”) of acquiring the pattern image acquired from one or more superimposed subframes (here, first superimposed subframe SF21 and second superimposed subframe SF22) according to a result of acquiring the pattern image (here, third pattern image PP3). In the embodiment, an entity executing adjusting is the deviation correction unit 34 of the control device 3.

In adjusting, first, it is determined whether to increase or decrease the degree according to the a result of acquiring the pattern image (third pattern image PP3). Specifically, the deviation correction unit 34 detects one or more feature points SP1 included in the third pattern image PP3 and counts the detected one or more feature points SP1. Then, the deviation correction unit 34 determines whether a ratio of the number of the detected one or more feature points SP1 to the number of all the feature points SP1 included in the third pattern image PP3 is equal to or greater than a threshold (for example, 80%). When the ratio is equal to or greater than the threshold, the deviation correction unit 34 determines to maintain the degree without increasing or decreasing. On the other hand, when the ratio is less than the threshold value, the deviation correction unit 34 determines to increase or decrease the degree (here, increase the degree).

Hereinafter, first to third examples of adjusting for increasing or decreasing the degree will be listed. Note that in the first to third examples listed below, any one example may be employed for adjusting, or two or more examples may be combined and employed for adjusting.

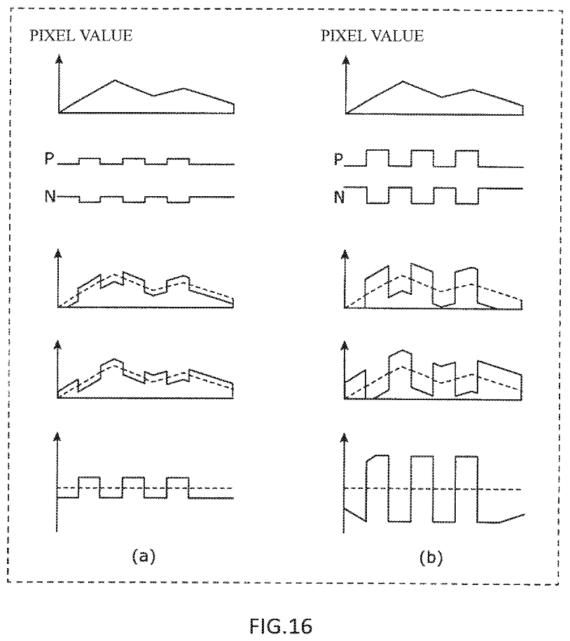

FIG. 16 is an explanatory diagram of a first example of adjusting. (a) of FIG. 16 shows a case where the degree is relatively weak, and (b) of FIG. 16 shows a case where the degree is relatively strong. Each of (a) of FIG. 16 and (b) of FIG. 16 shows, in order from the top, the pixel value of the blue signal in one line in the horizontal direction of the original image, the pixel value of the blue signal in the one line of the first pattern image PP1, the pixel value of the blue signal in the one line of the second pattern image PP2, the pixel value of the blue signal in the one line of the first superimposed subframe SF21, the pixel value of the blue signal in the one line of the second superimposed subframe SF22, and the pixel value of the blue signal in the one line of the third pattern image PP3.

In the first example, as shown in FIG. 16, the degree is increased or decreased by increasing or decreasing pixel values of the pattern images (first pattern image PP1 and second pattern image PP2) to be superimposed on one or more subframes SF1. Specifically, as shown in (a) of FIG. 16, by decreasing the pixel value of the blue signal in each line of the first pattern image PP1 and the second pattern image PP2, the pixel value of the blue signal in each line of the third pattern image PP3 decreases. On the other hand, as shown in (b) of FIG. 16, by increasing the pixel value of the blue signal in each line of the first pattern image PP1 and the second pattern image PP2, the pixel value of the blue signal in each line of the third pattern image PP3 increases.

As described above, in the first example, the degree (here, the pixel value of the third pattern image PP3) is increased or decreased by increasing or decreasing the pixel values of the pattern images (first pattern image PP1 and second pattern image PP2) to be superimposed on the one or more subframes SF1. By increasing the pixel value of the third pattern image PP3, an SN ratio is improved, and the deviation correction unit 34 of the control device 3 easily detects one or more feature points SP1 included in the third pattern image PP3. However, in this case, in each of the first superimposed subframe SF21 and the second superimposed subframe SF22, the first pattern image PP1 and the second pattern image PP2 are conspicuous and easily perceived by the viewer.

On the other hand, by decreasing the pixel value of the third pattern image PP3, the first pattern image PP1 and the second pattern image PP2 are less likely to be conspicuous in each of the first superimposed subframe SF21 and the second superimposed subframe SF22, and are less likely to be perceived by the viewer. However, in this case, it is difficult for the deviation correction unit 34 of the control device 3 to detect one or more feature points SP1 included in the third pattern image PP3.

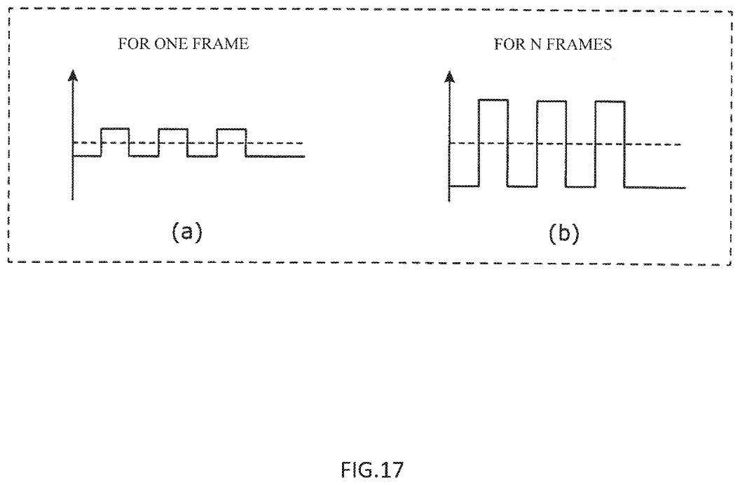

FIG. 17 is an explanatory diagram of a second example of adjusting. (a) of FIG. 17 shows a case where the degree is relatively weak, and (b) of FIG. 17 shows a case where the degree is relatively strong. (a) of FIG. 17 shows the pixel value of the blue signal in one line in the horizontal direction of the third pattern image PP3 for one frame, and (b) of FIG. 17 shows the pixel value of the blue signal in the one line of the third pattern image PP3 for N (N is a natural number of 2 or more) frames.

In the second example, as shown in FIG. 17, the degree is increased or decreased by increasing or decreasing the number of pattern images (third pattern images PP3) acquired from the one or more subframes SF1. Specifically, as shown in (a) of FIG. 17, when the number of the third pattern images PP3 to be added is small (here, for one frame), the pixel value of the blue signal in each line of the third pattern image PP3 after addition decreases. On the other hand, as shown in (b) of FIG. 17, when the number of the third pattern images PP3 to be added is large (here, for N frames), the pixel value of the blue signal in each line of the third pattern image PP3 after addition increases.

As described above, in the second example, the degree (here, the pixel value of the third pattern image PP3 after addition) is increased or decreased by increasing or decreasing the number of pattern images (third pattern images PP3) acquired from the one or more subframes SF1. By increasing the number of the third pattern images PP3 to be added, the SN ratio is improved, and the deviation correction unit 34 of the control device 3 easily detects one or more feature points SP1 included in the third pattern image PP3 after addition. However, in this case, it is necessary to wait until the plurality of third pattern images PP3 are acquired, and a time required for the processing tends to be long.

On the other hand, by reducing the number of third pattern images PP3 to be added, it is easy to shorten the time required for the above processing. However, in this case, since the pixel value of the third pattern image PP3 after addition is small, it is difficult for the deviation correction unit 34 of the control device 3 to detect one or more feature points SP1 included in the third pattern image PP3.

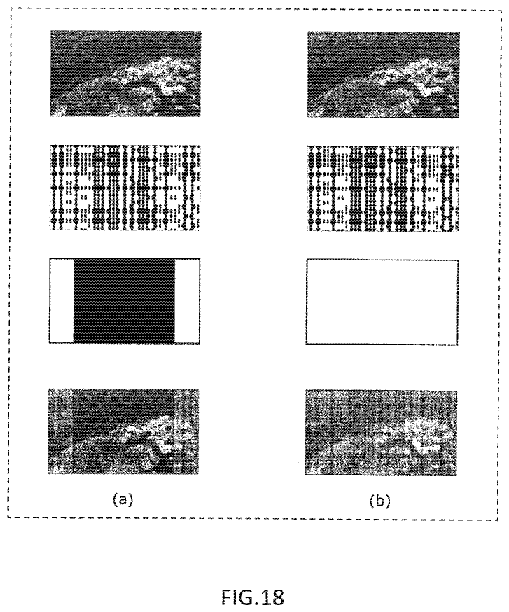

FIG. 18 is an explanatory diagram of a third example of adjusting. (a) of FIG. 18 shows a case where the degree is relatively weak, and (b) of FIG. 18 shows a case where the degree is relatively strong. Each of (a) of FIG. 18 and (b) of FIG. 18 shows, in order from the top, the original image, the pattern images (first pattern image PP1 and second pattern image PP2), a mask image, and an image in which the pattern image and the mask image are superimposed on the original image. In the mask image, a white region represents a region that transmits the pattern image, and a black region represents a region that shields the pattern image. Therefore, in the image in which the pattern image and the mask image are superimposed on the original image, the pattern image is superimposed on the original image in a region corresponding to the white region of the mask image, and the original image remains in a region corresponding to the black region of the mask image.

In the third example, as shown in FIG. 18, the degree is increased or decreased by increasing or decreasing areas of the pattern images (first pattern image PP1 and second pattern image PP2) to be superimposed on the one or more subframes SF1. Specifically, as shown in (a) of FIG. 18, by increasing an area of the black region of the mask image, the area of the pattern image to be superimposed on the subframe SF1 is reduced. On the other hand, as shown in (b) of FIG. 18, by reducing the area of the black region of the mask image, the area of the pattern image to be superimposed on the subframe SF1 increases.

As described above, in the third example, the degree (here, the area of the first pattern image PP1 or the second pattern image PP2 in the superimposed subframe) is increased or decreased by increasing or decreasing the areas of the pattern images (first pattern image PP1 and second pattern image PP2) to be superimposed on the one or more subframes SF1. By increasing the area of the first pattern image PP1 or the second pattern image PP2 in the superimposed subframe, the SN ratio is improved, and the deviation correction unit 34 of the control device 3 easily detects one or more feature points SP1 included in the third pattern image PP3. However, in this case, in each of the first superimposed subframe SF21 and the second superimposed subframe SF22, the first pattern image PP1 and the second pattern image PP2 are conspicuous and easily perceived by the viewer.

On the other hand, by reducing the area of the first pattern image PP1 or the second pattern image PP2 in the superimposed subframe, the first pattern image PP1 and the second pattern image PP2 are less likely to be conspicuous in each of the first superimposed subframe SF21 and the second superimposed subframe SF22, and are less likely to be perceived by the viewer. However, in this case, it is difficult for the deviation correction unit 34 of the control device 3 to detect one or more feature points SP1 included in the third pattern image PP3.

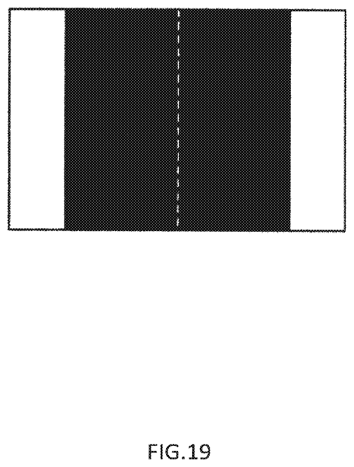

Note that in the embodiment, as described above, the composite video is projected on the display surface 50 by projecting the videos respectively from the two projection devices 1A and 1B onto the display surface 50. Therefore, in the embodiment, the composite mask image is projected on the display surface 50 by projecting mask images divided respectively from the two projection devices 1A and 1B onto the display surface 50. FIG. 19 is a diagram showing an example of the mask image used in the third example of adjusting. In the example shown in FIG. 19, a right-half mask image is a mask image projected from the projection device 1A, and a left-half mask image is a mask image projected from the projection device 1B. These mask images are projected as one composite mask image on the display surface 50.

### [3-3. Main Operation]

Next, an operation example of a main operation of the video processing system 100 according to the embodiment will be described. In the embodiment, the video processing system 100 determines whether to superimpose the pattern images (first pattern image PP1 and second pattern image PP2) on the frame F1, in other words, whether to display the first superimposed subframe SF21 and the second superimposed subframe SF22 on the display surface 50, based on a detection result of the sensor 6 (see FIG. 1).

The sensor 6 is, for example, a human sensor, and detects a person around the display surface 50 of the screen 5. The sensor 6 transmits a signal including the detection result (hereinafter, also referred to as a “detection signal”) to the control device 3. Then, when the detection result of the sensor 6 indicates that there is a person around the display surface 50, that is, when it is estimated that there is a viewer of the video projected on the display surface 50, the control device 3 determines not to display the first superimposed subframe SF21 and the second superimposed subframe SF22 on the display surface 50. On the other hand, when the detection result of the sensor 6 indicates that there is no person around the display surface 50, that is, when it is estimated that there is no viewer, the control device 3 determines to display the first superimposed subframe SF21 and the second superimposed subframe SF22 on the display surface 50.

Note that, for example, a camera that captures an image of the person around the display surface 50 of the screen 5 may be used instead of the sensor 6. In this case, by performing appropriate image analysis processing on the image captured by the camera, it is possible to estimate whether there is a person around the display surface 50 similarly to a case of referring to the detection result of the sensor 6.

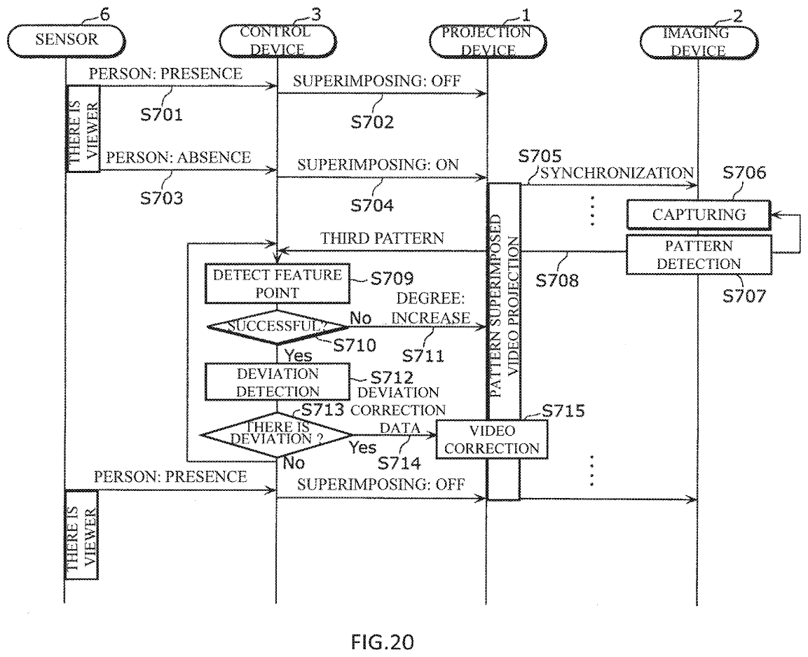

FIG. 20 is a sequence diagram showing an operation example of the video processing system 100 according to the embodiment. First, when there is the viewer of the video projected on the display surface 50, the sensor 6 transmits the detection signal including the detection result indicating that there is the person around the display surface 50 to the control device 3 (S701). Then, the control device 3 stops outputting the one or more superimposed subframes (here, first superimposed subframe SF21 and second superimposed subframe SF22) so as to be displayed on the display surface 50 (S702). Step S702 corresponds to setting the degree to zero in adjusting.

Thereafter, when there is no viewer around the display surface 50, the sensor 6 transmits the detection signal including the detection result indicating that there is no person around the display surface 50 to the control device 3 (S703). Then, the control device 3 resumes outputting (S704). Step S704 corresponds to returning the degree to default in adjusting.

When the control device 3 resumes outputting, the projection device 1 transmits the synchronization signal to the imaging device 2 (S705). The imaging device 2 captures the video projected on the display surface 50 based on the synchronization signal transmitted from the projection device 1 (S706). Then, the imaging device 2 detects the pattern image (third pattern image PP3) from the one or more superimposed subframes (first superimposed subframe SF21 and second superimposed subframe SF22) obtained by capturing the video (S707). The imaging device 2 transmits the detected third pattern image PP3 to the control device 3 (S708). The third pattern image PP3 includes the third pattern image PP3 for the R channel, the third pattern image PP3 for the G channel, and the third pattern image PP3 for the B channel. Steps S705 to S708 are repeated until the control device 3 receives the detection signal including the detection result indicating that there is no person around the display surface 50.

When acquiring the third pattern image PP3 transmitted from the imaging device 2, the control device 3 performs adjustment. First, the control device 3 detects one or more feature points SP1 included in the third pattern image PP3 (S709). Next, the control device 3 determines whether a ratio (hereinafter, also referred to as a “detection rate”) of the number of the detected one or more feature points SP1 to the number of all the feature points SP1 included in the third pattern image PP3 is equal to or larger than the threshold (for example, 80%) (S710). If the determination fails (S710: No), in other words, if the detection rate is less than the threshold, the control device 3 increases the degree (S711). For example, when the first example of adjustment is applied, the control device 3 instructs the projection device 1 to increase the pixel values of the pattern images (first pattern image PP1 and second pattern image PP2) to be superimposed on the one or more subframes SF1.

On the other hand, if the determination is successful (S710: Yes), in other words, if the detection rate is equal to or greater than the threshold, the control device 3 detects the deviation of the display position of the video projected on the display surface 50 by comparing the detected feature point SP1 of the third pattern image PP3 with the reference feature point (S712). If there is no deviation in the position of the feature point SP1 (S713: No), the control device 3 does not update the LUT for geometric correction and the initial data. On the other hand, if there is deviation in the position of the feature point SP1 (S713: Yes), the control device 3 updates the LUT for geometric correction so that the deviation is zero, and transmits the updated LUT data for geometric correction (deviation correction data) to the projection device 1 (S714). Thereafter, the projection device 1 geometrically corrects the internal video signal according to the acquired LUT data for geometric correction (S715). Steps S709 to S715 are repeated until the control device 3 receives the detection signal including the detection result indicating that there is no person around the display surface 50.

### [4. Advantages and the Like]

Hereinafter, advantages of the video processing system 100 (video processing method) according to the embodiment will be described. As described above, the video processing system 100 according to the embodiment adjusts the degree by increasing or decreasing the degree of acquiring the pattern image from one or more acquired superimposed subframes (first superimposed subframe SF21 and second superimposed subframe SF22) according to the a result of acquiring the pattern image (third pattern image PP3).

Therefore, in the video processing system 100 according to the embodiment, since the degree of acquiring the pattern image can be adjusted to such an extent that the pattern image can be sufficiently detected, it is easy to superimpose the pattern image on the one or more subframes SF1 in such a manner that the pattern image is hardly perceived by the viewer as compared with a case where the degree of acquiring the pattern image is uniformly increased. Therefore, the video processing system 100 according to the embodiment has an advantage that the pattern image to be superimposed on the video in order to correct the deviation of the display position of the video is easily detected without being perceived by the viewer.

In addition, when it is difficult for the imaging device 2 to capture the video due to an environment around the screen 5, when the superimposed pattern images (first pattern image PP1 and second pattern image PP2) are patterns that are difficult to be detected, or the like, detection of the pattern image (third pattern image PP3) may fail. Even in such a case, in the video processing system 100 according to the embodiment, since the degree of acquiring the pattern image can be adjusted, there is an advantage that the pattern image is easily successfully detected.

In addition, the video processing system 100 according to the embodiment acquires the detection result of the sensor 6, that is, the presence/absence information indicating whether there is a person viewing the display surface 50, stops adjusting when the acquired presence/absence information indicates that there is the person, and adjusts when the presence/absence information indicating that there is no person is acquired. Therefore, there is the advantage that since the video processing system 100 according to the embodiment does not increase or decrease the degree of acquiring the pattern image when there is the viewer, the pattern image is less likely to be perceived by the viewer.

Furthermore, the video processing system 100 according to the embodiment stops outputting when the presence/absence information indicates that there is a person. Therefore, the video processing system 100 according to the embodiment has an advantage that the pattern image is not perceived by the viewer because the pattern image is not superimposed on the one or more subframes SF1 when there is the viewer.

### 5. Other Embodiments

Although the embodiment has been described above, the present disclosure is not limited to the above embodiment.

### [5-1. First Modification]

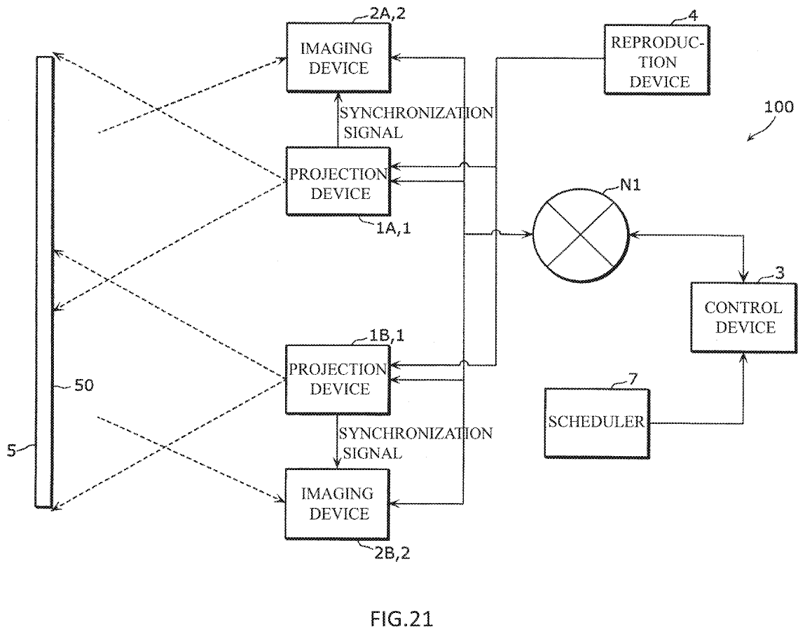

FIG. 21 is a schematic diagram showing an overall configuration including the video processing system 100 according to a first modification of the embodiment. The first modification is different from the video processing system 100 according to the embodiment in that a scheduler 7 is used instead of the sensor 6.

The scheduler 7 is, for example, an information terminal such as a desktop or laptop personal computer that cooperates with a video projection system, and manages a projection schedule. Note that the scheduler 7 may be integrated with the control device 3.

The scheduler 7 transmits a signal to the control device 3 according to the projection schedule. Then, when the signal indicates that the projection starts, that is, when it is estimated that there is the viewer of the video projected on the display surface 50, the control device 3 determines not to display the first superimposed subframe SF21 and the second superimposed subframe SF22 on the display surface 50. On the other hand, when the signal indicates that the projection ends, that is, when it is estimated that there is no viewer due to a change of viewers or the like until next projection, the control device 3 determines to display the first superimposed subframe SF21 and the second superimposed subframe SF22 on the display surface 50.

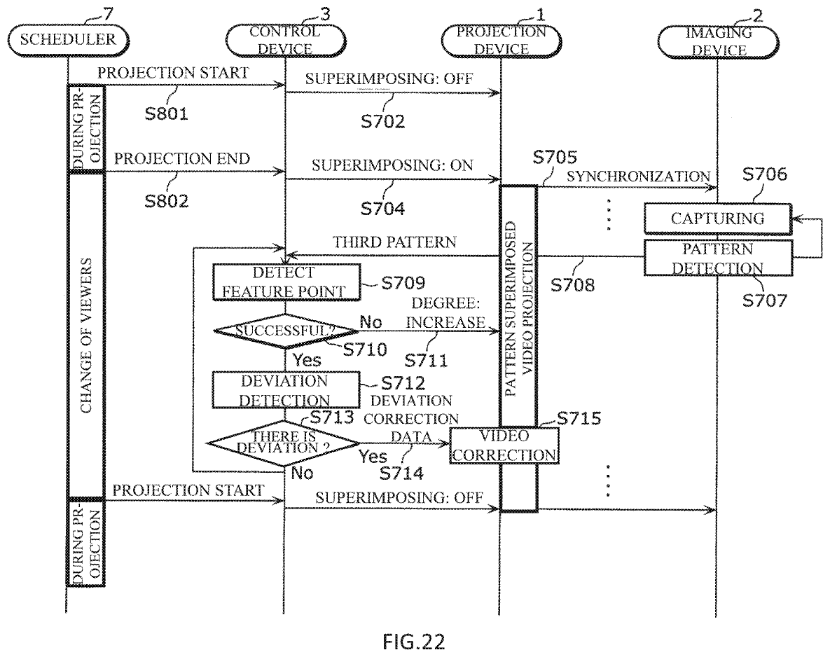

FIG. 22 is a sequence diagram showing the operation example of the video processing system 100 according to the first modification of the embodiment. In the following description, steps S702 and S704 to S715 are the same as those in the embodiment, and thus detailed description thereof will be omitted.

First, the scheduler 7 transmits a signal indicating that the projection starts to the control device 3 (S801). Then, the control device 3 performs step S702. Thereafter, the scheduler 7 transmits a signal indicating that the projection ends to the control device 3 (S802). Then, the control device 3 performs step S704. Thereafter, steps S705 to S708 are repeated until the control device 3 receives the signal indicating that the projection ends. Further, thereafter, steps S709 to S715 are repeated until the control device 3 receives the signal indicating that the projection ends.

In the first modification, since outputting is stopped during the projection, that is, when it is estimated that there is the viewer of the video projected on the display surface 50 of the screen 5, there is the advantage that the pattern image is not perceived by the viewer, similarly to the embodiment.

### [5-2. Second Modification]

The second modification is different from the video processing system 100 according to the embodiment in that outputting is always performed regardless of the detection result of the sensor 6, that is, regardless of whether there is a viewer. Then, in the second modification, when the detection result of the sensor 6 indicates that there is a person around the display surface 50, that is, when it is estimated that there is the viewer of the video projected on the display surface 50, the control device 3 adjusts after reducing the degree. Note that how much the degree is reduced may be appropriately set by the user. On the other hand, when the detection result of the sensor 6 indicates that there is no person around the display surface 50, that is, when it is estimated that there is no viewer, the control device 3 stops adjusting after increasing the degree. Note that how much the degree is increased may be appropriately set by the user.

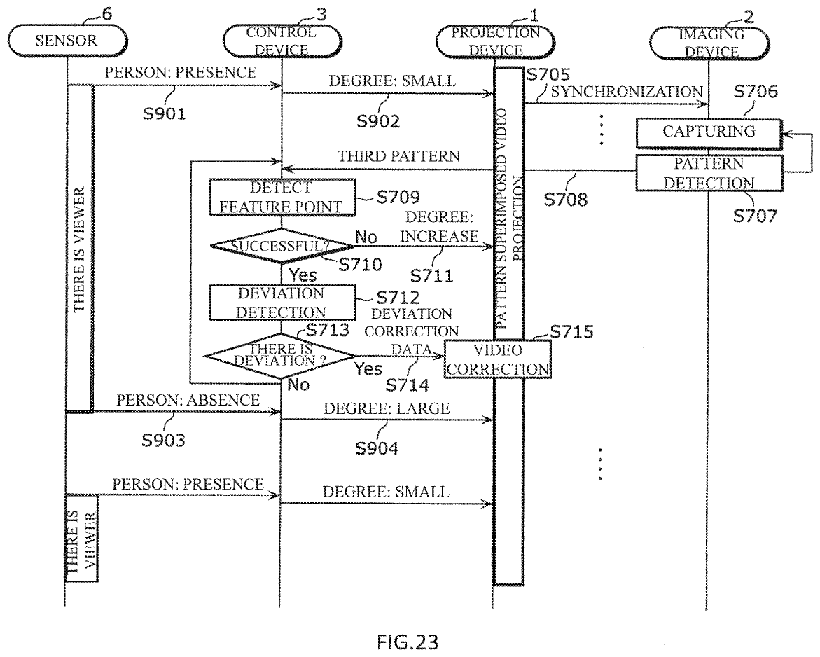

FIG. 23 is a sequence diagram showing the operation example of the video processing system 100 according to the second modification of the embodiment. In the following description, steps S705 to S715 are the same as those in the embodiment, and thus detailed description thereof will be omitted. Further, in the following description, it is assumed that the control device 3 always performs output.

First, when there is the viewer of the video projected on the display surface 50, the sensor 6 transmits the detection signal including the detection result indicating that there is the person around the display surface 50 to the control device 3 (S901). Then, the control device 3 reduces the degree in adjusting (S902). Thereafter, steps S705 to S708 are repeated until the control device 3 receives the detection signal including the detection result indicating that there is no person around the display surface 50. Further, thereafter, steps S709 to S715 are repeated until the control device 3 receives the detection signal including the detection result indicating that there is no person around the display surface 50.

Thereafter, when there is no viewer around the display surface 50, the sensor 6 transmits the detection signal including the detection result indicating that there is no person around the display surface 50 to the control device 3 (S903). Then, the control device 3 increases the degree in adjusting (S904). Thereafter, the control device 3 stops adjusting until the detection signal including the detection result indicating that there is the person around the display surface 50 is received.

In the second modification, since the degree in adjusting is reduced when it is estimated that there is the viewer around the display surface 50 of the screen 5, there is an advantage that the pattern image is hardly perceived by the viewer.

Note that in the second modification, the degree in adjusting is increased until the detection rate becomes equal to or greater than the threshold in steps S709 to S711, but the degree in adjusting in step S904 is set as an upper limit.

In the second modification, the scheduler 7 may be used instead of the sensor 6. In this case, when receiving the signal indicating a start of the projection from the scheduler 7, the control device 3 adjusts after reducing the degree. When receiving the signal indicating an end of the projection from the scheduler 7, the control device 3 stops adjusting after increasing the degree.

### [5-3. Other Modifications]

For example, in the above embodiment, the control device 3 may reduce the degree during adjustment if the detection rate is greater than or equal to the predetermined value, wherein the predetermined value (for example, 90%) is greater than the threshold.

For example, in the above embodiment, the control device 3 may increase the degree in adjusting when the detection rate of the feature point is continuously equal to or greater than a predetermined number of times and less than the threshold. Thus, for example, even when a scene in which the detection is difficult continues, a success rate of the detection of the feature point can be increased.

For example, in the above embodiment, the first pattern image PP1 and the second pattern image PP2 are respectively superimposed on the first subframe and the second subframe, which are the same images based on the plurality of subframes SF1, but are not limited thereto. For example, the first subframe and the second subframe may be images different from each other. In addition, it is sufficient that the pattern image can be acquired by imaging the superimposed subframe in which the pattern image is superimposed on the one or more subframes SF1, and a method of superimposing the pattern image on the one or more subframes SF1 is not limited to the method in the above embodiment.

For example, in the above embodiment, the video processing system 100 is implemented by a plurality of devices, but is not limited thereto. For example, the video processing system 100 may be implemented by a single device.

In the above embodiment, processing performed by a specific processing unit may be performed by another processing unit. Furthermore, order of a plurality of processes may be changed, or the plurality of processes may be performed in parallel.

In the above embodiment, each component may be implemented by executing a software program suitable for each component. Each component may be implemented by a program execution unit such as a CPU or a processor reading and executing the software program recorded in a recording medium such as a hard disk or a semiconductor memory.

Each component may be implemented by hardware. Each component may be a circuit (or an integrated circuit). These circuits may constitute one circuit as a whole or may be separate circuits. Each of these circuits may be a general-purpose circuit or a dedicated circuit.

The general or specific aspect of the present disclosure may be realized by a system, a device, a method, an integrated circuit, a computer program, or a recording medium such as a computer-readable CD-ROM. In addition, the aspect may be realized by an arbitrary combination of the system, the device, the method, the integrated circuit, the computer program, and the recording medium.

Further, the present disclosure may be realized as the video processing method executed by the computer such as the video processing system of the above embodiments. The present disclosure may be realized as a program (computer program product) for causing the computer to execute such a video processing method, or may be realized as a computer-readable non-transitory recording medium in which such a program is recorded.

In addition, the present disclosure also includes a mode obtained by applying various modifications conceived by those skilled in the art to each embodiment, or a mode realized by arbitrarily combining components and functions in each embodiment without departing from the gist of the present disclosure.

### SUMMARY

As described above, in the video processing method according to a first aspect, the plurality of subframes SF1 obtained by temporally dividing the frame F1 included in the video data are acquired. Further, in the video processing method, outputting the one or more superimposed subframes obtained by superimposing the pattern image on the one or more subframes SF1 based on the plurality of subframes SF1 so as to be displayed on the display surface 50 is performed. Further, in the video processing method, the one or more superimposed subframes displayed on the display surface 50 are acquired by imaging. Further, in the video processing method, the pattern image is acquired from the acquired one or more superimposed subframes. Further, in the video processing method, the deviation of the display position of the video projected on the display surface 50 is detected by comparing the feature point SP1 of the acquired pattern image with the reference feature point. Furthermore, in the video processing method, adjusting the degree of acquiring the pattern image from the one or more acquired superimposed subframes by increasing or decreasing the degree according to the result of acquiring the pattern image.

In such a video processing method, since the degree of acquiring the pattern image can be adjusted to such an extent that the pattern image can be sufficiently detected, it is easy to superimpose the pattern image on the one or more subframes SF1 in such a manner that the pattern image is hardly perceived by the viewer as compared with the case where the degree of acquiring the pattern image is uniformly increased. Therefore, such a video processing method has the advantage that the pattern image to be superimposed on the video in order to correct the deviation of the display position of the video is easily detected without being perceived by the viewer.

For example, in the video processing method according to a second aspect, in the first aspect, the degree is increased or decreased by increasing or decreasing the pixel value of the pattern image to be superimposed on the one or more subframes SF1 in adjusting.

Such a video processing method has an advantage that the SN ratio is easily adjusted since the pixel value of the pattern image to be acquired can be increased or decreased.

For example, in the video processing method according to a third aspect, in the first or second aspect, the degree is increased or decreased by increasing or decreasing the number of pattern images acquired from the one or more superimposed subframes in adjusting.

Such a video processing method has the advantage that the SN ratio is easily adjusted since the number of pattern images to be added can be increased or decreased.

For example, in the video processing method according to a fourth aspect, in any one of the first to third aspects, the degree is increased or decreased by increasing or decreasing the area of the pattern image to be superimposed on the one or more superimposed subframes in adjusting.

Such a video processing method has the advantage that the SN ratio is easily adjusted since the area of the pattern image to be acquired can be increased or decreased.

For example, in the video processing method according to a fifth aspect, in any one of the first to fourth aspects, the presence/absence information indicating whether there is a person viewing the display surface 50 is acquired. Further, in the video processing method, adjusting is stopped when the acquired presence/absence information indicates that there is a person, and adjusting is performed when the acquired presence/absence information indicates that there is no person.

Such a video processing method has an advantage that since the degree of acquiring the pattern image is not increased or decreased when there is the viewer, the pattern image is less likely to be perceived by the viewer.

For example, in the video processing method according to a sixth aspect, in the fifth aspect, outputting is stopped when the presence/absence information indicates that there is a person viewing the display surface 50.

Such a video processing method has an advantage that the pattern image is not perceived by the viewer because the pattern image is not superimposed on the one or more subframes SF1 when there is the viewer.

For example, in the video processing method according to a seventh aspect, in any one of the first to sixth aspects, the one or more superimposed subframes include: a first superimposed subframe SF21 obtained by superimposing the first pattern image PP1, on the first subframe based on the plurality of subframes SF1; and a second superimposed subframe SF22 obtained by superimposing the second pattern image PP2 obtained by inverting a pixel value of the first pattern image PP1, on a second subframe based on the plurality of subframes SF1. Further, in the video processing method, the first superimposed subframe SF21 and the second superimposed subframe SF22 displayed on the display surface 50 are acquired by imaging. Further, in the video processing method, the third pattern image PP3 which is a pattern image is acquired from the difference between the acquired first superimposed subframe SF21 and second superimposed subframe SF22. Furthermore, in the video processing method, the deviation of the display position of the video projected on the display surface 50 is detected by comparing the feature point SP1 of the acquired third pattern image PP3 with the reference feature point.

In such a video processing method, since the degree of acquiring the third pattern image PP3 can be adjusted to such an extent that the third pattern image PP3 can be sufficiently detected, there is an advantage that it is easy to superimpose the first pattern image PP1 and the second pattern image PP2 on the one or more subframes SF1 in such a manner that the first pattern image PP1 and the second pattern image PP2 are hardly perceived by the viewer as compared with a case where the degree of acquiring the third pattern image PP3 is uniformly increased.

For example, the program according to an eighth aspect causes one or more processors to execute the video processing method according to any one of the first to seventh aspects.

In such a program, since the degree of acquiring the pattern image can be adjusted to such an extent that the pattern image can be sufficiently detected, it is easy to superimpose the pattern image on the one or more subframes SF1 in such a manner that the pattern image is hardly perceived by the viewer as compared with the case where the degree of acquiring the pattern image is uniformly increased. Therefore, such a program has the advantage that the pattern image to be superimposed on the video in order to correct the deviation of the display position of the video is easily detected without being perceived by the viewer.

For example, the video processing system 100 according to a ninth aspect includes a first acquisition unit (the video generating unit 12 of the projection device 1), an output unit (the video generating unit 12, the video selecting unit 14, and the video projecting unit 15 of the projection device 1), a second acquisition unit (the imaging unit 24 and the pattern detection unit 25 of the imaging device 2), a third acquisition unit (the pattern detection unit 25 of the imaging device 2), a detection unit (the deviation correction unit 34 of the control device 3), and an increase/decrease unit (the deviation correction unit 34 of the control device 3). The first acquisition unit acquires the plurality of subframes SF1 obtained by temporally dividing the frame F1 included in the video data. The output unit outputs the one or more superimposed subframes obtained by superimposing the pattern image on the one or more subframes SF1 based on the plurality of subframes SF1 so as to be displayed on the display surface 50. The second acquisition unit acquires the one or more superimposed subframes displayed on the display surface 50 by imaging. The third acquisition unit acquires the pattern image from the acquired one or more superimposed subframes. The detection unit detects the deviation of the display position of the video projected on the display surface 50 by comparing the feature point SP1 of the acquired pattern image with the reference feature point. The adjusting unit performs adjusting the degree of acquiring the pattern image from one or more acquired superimposed subframes by increasing or decreasing the degree according to the result of acquiring the pattern image.

Since such a video processing system 100 can adjust the degree of acquiring the pattern image to such an extent that the pattern image can be sufficiently detected, it is easy to superimpose the pattern image on the one or more subframes SF1 in such a manner that the pattern image is hardly perceived by the viewer as compared with the case where the degree of acquiring the pattern image is uniformly increased. Therefore, such a video processing system 100 has the advantage that the pattern image to be superimposed on the video in order to correct the deviation of the display position of the video is easily detected without being perceived by the viewer.

The video processing method or the like of the present disclosure can be used for a system or the like that corrects the deviation of the display position of the video projected on the display surface such as the screen.

What is claimed is:

1. A video processing method comprising:
acquiring a plurality of subframes obtained by temporally dividing a frame included in video data;
outputting one or more superimposed subframes in which a pattern image is superimposed on one or more subframes based on the plurality of subframes so as to be displayed on a display surface;
acquiring the one or more superimposed subframes displayed on the display surface by imaging;
acquiring the pattern image from the one or more superimposed subframes acquired;
adjusting a degree of acquiring the pattern image from the one or more superimposed subframes acquired by increasing or decreasing the degree according to a result of acquiring the pattern image.

2. The video processing method according to claim 1, wherein
in the adjusting, the degree is increased or decreased by increasing or decreasing a pixel value of the pattern image to be superimposed on the one or more subframes.

3. The video processing method according to claim 1, wherein
in the adjusting, the degree is increased or decreased by increasing or decreasing the number of the pattern images acquired from the one or more superimposed subframes.

4. The video processing method according to claim 1, wherein
the degree is increased or decreased by increasing or decreasing an area of the pattern image to be superimposed on the one or more superimposed subframes in the adjusting.

5. The video processing method according to claim 1, comprising:
acquiring presence/absence information indicating whether there is a person viewing the display surface, and
stopping the adjustment when the presence/absence information acquired indicates that there is the person, and adjusting when the presence/absence information acquired indicates that there is not the person.

6. The video processing method according to claim 2, comprising:
acquiring presence/absence information indicating whether there is a person viewing the display surface, and
stopping the adjustment when the presence/absence information acquired indicates that there is the person, and adjusting when the presence/absence information acquired indicates that there is not the person.

7. The video processing method according to claim 3, comprising:
acquiring presence/absence information indicating whether there is a person viewing the display surface, and
stopping the adjustment when the presence/absence information acquired indicates that there is the person, and adjusting when the presence/absence information acquired indicates that there is not the person.

8. The video processing method according to claim 4, comprising:
acquiring presence/absence information indicating whether there is a person viewing the display surface, and
stopping the adjustment when the presence/absence information acquired indicates that there is the person, and adjusting when the presence/absence information acquired indicates that there is not the person.

9. The video processing method according to claim 5, comprising
stopping the output processing when the presence/absence information indicates that there is a person viewing the display surface.

10. The video processing method according to claim 6, comprising
stopping the output processing when the presence/absence information indicates that there is a person viewing the display surface.

11. The video processing method according to claim 7, comprising
stopping the output processing when the presence/absence information indicates that there is a person viewing the display surface.

12. The video processing method according to claim 8, comprising
stopping the output processing when the presence/absence information indicates that there is a person viewing the display surface.

13. The video processing method according to claim 1, comprising
detecting a deviation of a display position of a video projected on the display surface by comparing a feature point of the pattern image acquired with a reference feature point.

14. The video processing method according to claim 1, wherein
the one or more superimposed subframes include a first superimposed subframe obtained by superimposing a first pattern image on a first subframe based on the plurality of subframes, and a second superimposed subframe obtained by superimposing a second pattern image obtained by inverting a pixel value of the first pattern image on a second subframe based on the plurality of subframes,
the video processing method comprising:
acquiring the first superimposed subframe and the second superimposed subframe displayed on the display surface by imaging,
acquiring a third pattern image that is the pattern image from a difference between the first superimposed subframe acquired and the second superimposed subframe acquired, and
detecting a deviation of a display position of a video projected on the display surface by comparing a feature point of the third pattern image acquired with a reference feature point.

15. The video processing method according to claim 2, wherein
the one or more superimposed subframes include a first superimposed subframe obtained by superimposing a first pattern image on a first subframe based on the plurality of subframes, and a second superimposed subframe obtained by superimposing a second pattern image obtained by inverting a pixel value of the first pattern image on a second subframe based on the plurality of subframes,
the video processing method comprising:
acquiring the first superimposed subframe and the second superimposed subframe displayed on the display surface by imaging,
acquiring a third pattern image that is the pattern image from a difference between the first superimposed subframe acquired and the second superimposed subframe acquired, and
detecting a deviation of a display position of a video projected on the display surface by comparing a feature point of the third pattern image acquired with a reference feature point.

16. A program causing one or more processors to execute the video processing method according to claim 1.

17. A program causing one or more processors to execute the video processing method according to claim 2.

18. A program causing one or more processors to execute the video processing method according to claim 3.

19. A program causing one or more processors to execute the video processing method according to claim 4.

20. A video processing system comprising:
a first acquisition unit that acquires a plurality of subframes obtained by temporally dividing a frame included in video data;
an output unit that outputs one or more superimposed subframes in which a pattern image is superimposed on one or more subframes based on the plurality of subframes so as to be displayed on a display surface;
a second acquisition unit that acquires the one or more superimposed subframes displayed on the display surface by imaging;
a third acquisition unit that acquires the pattern image from the one or more superimposed subframes acquired;
an adjusting unit that adjusts a degree of acquiring the pattern image from the one or more superimposed subframes acquired by increasing or decreasing the degree according to a result acquiring of the pattern image.
